(19) United States
(12) Patent Application Publication
(10) Pub. No.: US 2014/0310582 A1
(43) Pub. Date: Oct. 16, 2014

(54) Apparatus and Method for Building an Electronic Form

(71) Applicant: DRAEGER MEDICAL SYSTEMS, INC., Andover, MA (US)

(72) Inventor: Jody Bardman, Green Lane, PA (US)

(73) Assignee: Draeger Medical Systems, Inc., Andover, MA (US)

(21) Appl. No.: 13/862,034

(22) Filed: Apr. 12, 2013

(51) Int. Cl. G06F 17/24

(52) U.S. Cl. CPC G06F 17/243
USPC 715/222

(57) ABSTRACT

A system and method for creating an electronic form used to chronicle a healthcare interaction between a patient and healthcare provider is provided. A repository stores form control data objects, each of the form control data objects enabling user data entry of information associated with a respective aspect of the healthcare interaction. A form processor acquires form control data objects associated with a particular healthcare interaction from the repository and generates form creation data including the acquired form control data objects and a formatting grid, the formatting grid receives at least one of the acquired form control data objects. A user interface generator generates a form creation user interface using the form creation data received from the form processor that enables a user to selectively position the at least one of the acquired form control data objects within the formatting grid in a desired position.

### FIELD OF THE INVENTION

This invention concerns an apparatus and method for creating electronic forms used in providing healthcare to patients and, more specifically, for selectively designing and modifying electronic forms using a set of form parameters associated with particular types of healthcare procedures.

### BACKGROUND OF THE INVENTION

In the course of providing healthcare to patients, it is necessary to generate patient record data associated with the various healthcare services provided. Healthcare services may include any interaction between the patient and any type of healthcare provider including, but not limited to, a visit to a healthcare facility (e.g. doctor office, hospital, out patient center, etc), a procedure performed on the patient, and/or a treatment prescribed to the patient. With each interaction between patient and healthcare provider, a need exists to quickly and reliably create a record of the transaction. There are many reasons that drive this need to quickly and reliably create patient record data associated with various healthcare transactions. Firstly, there is a strong need to provide the patient with a comprehensive and clear record of the nature of the healthcare transactions for both the patient's individual knowledge about their health and healthcare but also for other healthcare professionals/providers that may come in contact with the patient during further healthcare transactions. Having a complete picture of previous healthcare transactions including symptoms, treatments, prescriptions, and or procedures associated with the patient enhances the subsequent healthcare provider's ability to treat the patient. Secondly, it is important to create a record of all occurrences during respective healthcare transactions between patients and providers for billing purposes. As the cost of healthcare increases, there are increasing pressures on both providers and insurers to fully document all costs associated with providing healthcare to the patient. Lastly, there is the issue of provider liability for any alleged malfeasance committed by the provider during the healthcare transaction with the patient.

The use of electronic healthcare records has been touted as the solution which satisfies the need to quickly and reliably create medical records of healthcare transactions between patient and providers. The transition from paper records to electronic health records is ongoing. However, there are certain drawbacks associated with this transition. Specifically, the number, type and nature of healthcare transactions is vast with each transaction likely having unique parameters associated therewith. To date, to achieve this goal has been costly because there needs to be personnel to interface between healthcare providers (doctors, nurses, surgeons, etc) and programmers who are skilled in the art of coding graphical user interface displays representing forms that allow the healthcare providers to input the desired information. Therefore, to fully realize the goal of electronic healthcare records, a need exists to quickly create and modify electronic forms that enable providers to document information associated with healthcare transactions. A system according to invention principles addresses deficiencies of known systems.

### SUMMARY OF THE INVENTION

In one embodiment, a system for creating an electronic form used to chronicle a healthcare interaction between a patient and healthcare provider is provided. A repository stores form control data objects, each of the form control data objects enabling user data entry of information associated with a respective aspect of the healthcare interaction. A form processor acquires form control data objects associated with a particular healthcare interaction from the repository and generates form creation data including the acquired form control data objects and a formatting grid, the formatting grid receives at least one of the acquired form control data objects. A user interface generator generates a form creation user interface using the form creation data received from the form processor that enables a user to selectively position the at least one of the acquired form control data objects within the formatting grid in a desired position.

In another embodiment, a method of creating an electronic form used to chronicle a healthcare interaction between a patient and healthcare provider is provided. The method includes storing, in a repository, form control data objects, each of the form control data objects enabling user data entry of information associated with a respective aspect of the healthcare interaction. The method further includes acquiring, via a form processor, form control data objects associated with a particular healthcare interaction from said repository and generating form creation data including the acquired form control data objects and a formatting grid and receiving within the formatting grid at least one of the acquired form control data objects. The method also includes generating, via a user interface generator, a form creation user interface using the form creation data received from the form processor that enables a user to selectively position the at least one of the acquired form control data objects within the formatting grid in a desired position.

### BRIEF DESCRIPTION OF THE DRAWINGS

FIG. 1 depicts an exemplary block diagram of the form building apparatus according to invention principles;

FIG. 2 is an exemplary user interface enabling operation of the form building apparatus according to invention principles;

FIGS. 3-20 are exemplary screen shots detailing exemplary operation of the form building apparatus according to invention principles; and

FIG. 21 is an exemplary flow diagram detailing operation of the form building apparatus according to invention principles.

### DETAILED DESCRIPTION

A system and method for dynamically generating an electronic form for use in acquiring information associated with a patient during a healthcare interaction is provided. A healthcare interaction may be considered as any event that occurs between a person obtaining any form of healthcare and a healthcare provider who may be any individual able to provide healthcare to the patient. There are numerous types of healthcare interactions that occur on a daily basis when providing healthcare to a user and it is increasingly necessary to document and carefully track all information associated with these interactions. However, as the number and types of these interactions are so large, there needs to be a system that enables a healthcare provider in any environment to quickly generate a form for inputting the necessary information. To achieve this goal, the present system advantageously enables a healthcare provider to generate an electronic form via a user interface that provides the user with a set of form controls representing types of information associated with a particular healthcare interaction that may be dragged and dropped onto a formatting grid. The system further advantageously enables the user to selectively test and preview a completed user created form including all of the form controls within the program specifically designed for entering and documenting the information associated with the healthcare interaction.

The system generating the user interface including the form controls represents a specifically purposed apparatus for generating an electronic form that enables a healthcare provider to input and store information associated with a healthcare interaction between a patient and healthcare provider. Moreover, the form controls provided in the present system may represent a set of executable instructions that, when combined into the completed electronic form transform any computing device into a specifically purposed apparatus that enables collection and input of information associated with a healthcare interaction between a patient and healthcare provider.

Each form generated by the system may be selectively associated with a particular type of healthcare interaction. Each type of healthcare interaction may have unique information associated therewith. Thus, the system advantageously provides the user with a set of candidate form controls within the user interface that may be selected for incorporation into the form being created. A form control includes a set of executable instructions that allow a healthcare provider to input a respective piece of information associated with the healthcare interaction. The form control is represented within the user interface as a selectable image element that may be dragged to a position within the formatting grid. The image element representing the form control includes a name identifying the form control and an associated type of form control. In one embodiment, the name of the form control may be indicative of the nature of the information able to be received from the healthcare provider and the associated type of form control may represent the manner in which the information may be entered by the healthcare provider. For example, the name of the form control may be “blood pressure” and the associated type of form control may be “free form” such that a user may enter alphanumeric information representative of the patient's blood pressure. This is described for purposes of example only and the name of the form control may be anything that quickly identifies, to a user creating the form, the nature of the information to be received by the form control and the associated type of form control may be any type of image element able to receive user input. In one embodiment, the type of form control may include at least one of (a) a selection box (e.g. check box) that, when selected, indicates an aspect of the healthcare interaction that has or has not occurred; (b) a drop down list that selectively provides a user with a set of candidate information that may describe an aspect of the healthcare interaction; (c) a free form box that enables a user to selectively input alphanumeric information describing an aspect of the healthcare interaction; and (d) a calculation box that enables the user to enter multiple pieces of information to calculate a value of an aspect of the healthcare interaction. In another embodiment, the type of form control element may include an exclusivity form control element which may present the user with a plurality of information items describing an aspect of the healthcare interaction. The exclusivity form control element enables the user to select only a respective one of the plurality of information items. By enabling selection of only a single information item, the system automatically de-selects any previously selected information item.

In another embodiment, any number of form controls may be grouped together. This is particularly advantageous when there are a plurality of different types of information associated with one particular aspect of the healthcare interaction between the patient and provider. In this embodiment, the grouped form control elements may all be of the same associated type (e.g. all selection boxes) or may represent different associated types (e.g. one selection box and one drop down box). While the groups described above include two form controls, one skilled in the art will understand that any number of form controls that may be related to a particular aspect of a healthcare interaction may be grouped together thereby providing the healthcare provider with one single position within a form in which all relevant information associated with the particular aspect of healthcare interaction may be entered.

In another embodiment, the form controls may include stage identifiers that are indicative of the stage in which the particular information may be present for entry. In this embodiment, a particular healthcare interaction may include a plurality of different stages wherein the same information may be entered. The stage identifiers advantageously provide the user with a visual representation of when and where that particular information is to be entered. Additionally, the stage identifiers are selectable whereby selection of one or more stage identifiers associated with the particular information automatically sets that form control to be mandatory in the selected stage. By setting a form control as mandatory, the user creating the form specifies that the particular information associated with that form control must be entered. For example, if the healthcare interaction associated with the form is a surgical procedure, the stage identifier associated with the nature of the information to be entered may include a pre-operative stage, an operative stage and a post-operative stage. By selecting the stage identifier associated with one of these stages, the user advantageously ensures that the form will require a value to be input within the form at the particular stage.

The system may include a repository in which identifiers associated with all form controls may be stored and indexed. The identifiers associated with a respective form control allow for dynamic creation of the associated form control element in the completed electronic form. The form controls stored in the repository may be identifiers or links representing individually coded objects including all instructions and algorithms that are needed for the program in which the completed form is to be displayed to dynamically create the form control which allows a user to enter information. The repository may include a plurality of different types of form controls associated with various types of healthcare interactions and, in response to selection of a particular type of healthcare interaction, the set of candidate form controls are automatically provided within the form generating user interface. Moreover, when a particular form control is selected for inclusion within the formatting grid, the user interface selectively modifies the image element representing the selected form control to indicate that the form control has been selected. By modifying the image element, a user is prevented from re-selecting the particular form control to prevent a duplicate form control from being inserted into the form. This prevention occurs by disabling the form control data object from being selected and dragged onto a form being created. This is signified by modifying the image element representing the form control data object indicating that it is disabled. The user is automatically prevented from inserting a second copy of a previously selected form control data object by changing the appearance of the form control data object and preventing selection thereof by a user input device (e.g. mouse). The system further advantageously enables removal of a selected form control from within the formatting grid. Upon removal from the formatting grid, the image element representing the form control is further modified to its original state thereby indicating that the form control element is available for selection and re-incorporation into the formatting grid as needed.

This system advantageously enables healthcare providers to quickly create and save electronic forms in a manner that is most conducive for entering and documenting different types of healthcare interactions. By providing the healthcare provider with a set of candidate form controls that are individually coded objects, the system advantageously reduces the cost and number of hours associated with providing an electronic form that may be used for acquiring information associated with different healthcare interactions. Moreover, while the forms may be formatted differently by different users and may not include all of the same form controls in each form, the form controls that are the same enable input and acquisition of information in a like manner. This further advantageously enables a healthcare enterprise to easily document the same type of information in the same manner no matter the healthcare provider who was using the form. The form control data objects need only be coded once and, once stored and indexed within the repository, may be repeatedly used by different healthcare providers.

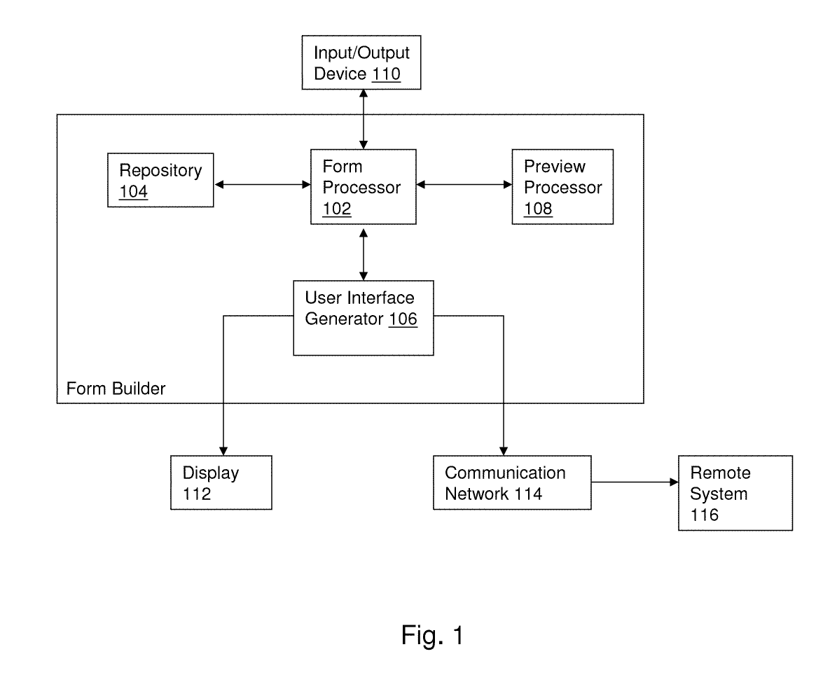

FIG. 1 is a block diagram of an exemplary form building apparatus 100 that enables a user to dynamically create at least one electronic form for recording information associated with at least one type of healthcare interaction. The apparatus 100 includes a form processor 102 that selectively controls the operation of the apparatus in terms of creating and building the at least one electronic form. A repository 104 is coupled to the form processor 102 and provides the form processor 102 with a set of form controls that may be incorporated into the electronic form being created by the apparatus 100. The repository 104 may be a data storage medium that selectively stores a data object (e.g. link or other type of identifier) representing at least one type of form control associated with at least one type of healthcare interaction. Typically, the repository 104 stores a plurality of data objects representing different form controls that are commonly associated with a particular type of healthcare interaction. In another embodiment, the repository 104 stores a plurality of data objects representing form controls that are associated with a plurality of different types of healthcare interactions.

In one embodiment, where the apparatus 100 enables creation of an electronic form for a specific type of healthcare interaction, the repository 104 may be indexed. This advantageously enables the form processor 102 to receive information identifying the form control data objects available for the particular type of healthcare interaction. In one example, the healthcare interaction for which the electronic form may be generated may be related to administration of anesthesia to a patient. In this example, the at least one electronic form may include at least one form control that enables user data entry of information associated with administration of anesthesia to the patient. In another embodiment, the apparatus 100 may enable creation of at least one electronic form for use in a plurality of different types of healthcare interactions.

In this embodiment, the repository 104 may include an index that links respective form control data objects stored in the repository 104 with the particular type of healthcare interaction to which they pertain. This advantageously reduces the amount of storage required in the repository for the form control data objects as the different types of interactions that employ common form control data objects may be used without storing separate instances of these objects in the repository 104. In this example, the healthcare interaction may be a surgical procedure and the repository may store form control data objects for different types of surgical procedures (e.g. cardiothoracic, orthopedic, neurological, etc) wherein each respective type of surgical procedure may have a set of form control data objects associated therewith. Some of these surgical procedures may have common form control data objects (e.g. form controls that enable input of a value representative of patient blood pressure). A single instance of a form control data object that is common between all types of surgical procedures may be stored in the repository and be linked with each respective type of surgical procedure. Moreover, the repository 104 may also store form control data objects unique to the different types of surgical procedures thereby advantageously enabling surgeons to create forms of their own design able to receive user data entry representing information associated with the type of surgical procedure.

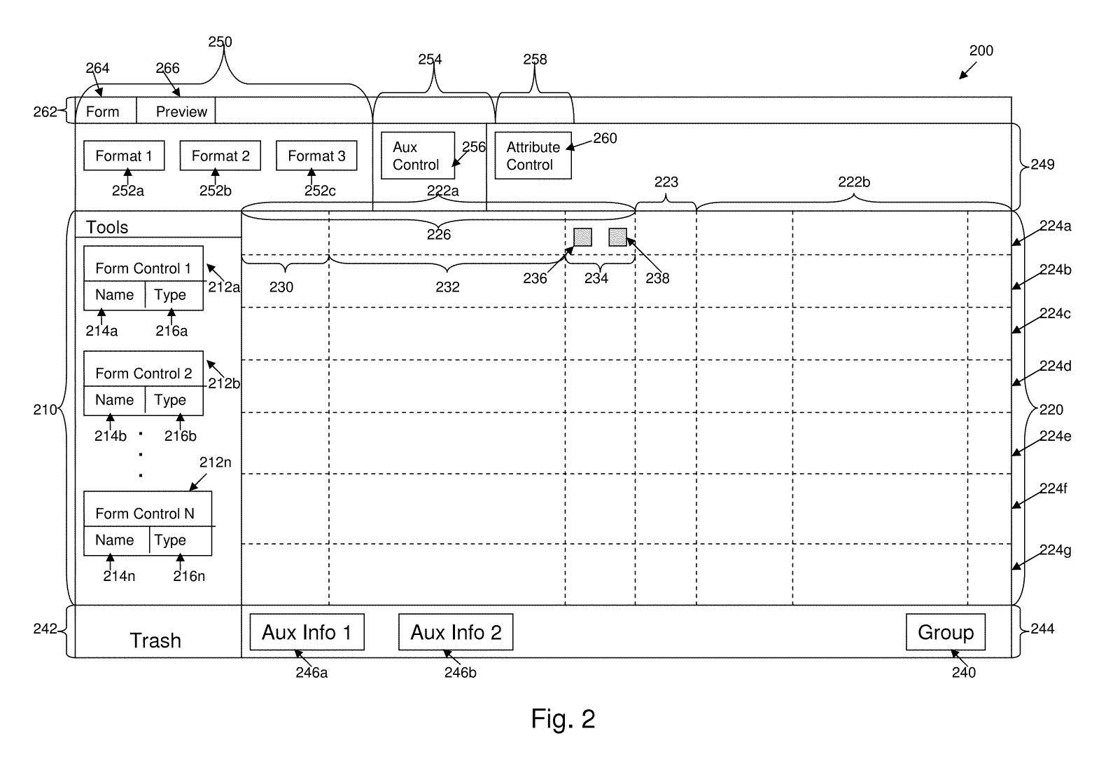

A user interface generator 106 is coupled to the form processor 102. The form processor 102 selectively controls the user interface (UI) generator 106 to generate a user interface display image representing a form building tool. The user interface display generated by the UI generator may be selectively displayable on display device 112. This provides the user creating the form with a visual cue as to the nature and design of the form being created in the manner discussed below with respect to FIG. 2. Alternatively, the UI generator 106 may generate the user interface display image and provide the generated display image to a remote system 116 via a communications network. This advantageously provides a healthcare provider the ability to access and generate any type of electronic form that may be used to chronicle a particular healthcare interaction between a provider and the patient.

A user may selectively interact with the form builder apparatus 100 via at least one type of input/output (I/O) device 110 that is selectively connected to the apparatus 100 and provides at least one type input signal from the user that controls the operation of the apparatus 100. The I/O device 110 may include at least one of a (a) keyboard; (b) mouse; (c) stylus; (d) touch screen; (e) motion capture camera able to record movements of a user and translate the movements into control signals; and (f) track pad. The user may selectively control the I/O device 110 to provide an input signal to the form processor 102 to control the generation of at least one electronic form. The user is provided with visual feedback during the process of creating the at least one electronic form because all movement and interaction of the I/O device 110 is visible on the display device 112.

In general operation, the user controls the I/O device 110 to select a type of form associated with a particular healthcare interaction. The form processor 102 receives the input signal selecting the type of form and associated healthcare interaction and queries the repository 104 for a candidate set of form control data objects for entering information associated with the healthcare interaction. The form control data objects represent a series of executable instructions that enable input and/or selection of a particular type of information associated with the healthcare interaction. The form processor 102 causes the UI generator 106 to generate a display image including user selectable image elements representing the candidate set of form control data objects and a formatting grid representing a layout of the at least one electronic form. The formatting grid advantageously enables a user to dynamically design and layout respective form control data objects within the electronic form being created. To do so, the user uses the I/O device 110 to select an image element representing at least one of the form control data objects from the image elements of the set of candidate form control data objects and drag the selected image element to a position within the formatting grid. Once dropped in the desired position, the form control data object automatically transforms from a representative image element into an object that receives user data entry of the desired information.

The apparatus further includes a preview processor 108 that is coupled to the form processor 102 and the UI generator 106. The preview processor 108 advantageously executes instructions that enable the at least one electronic form created to be displayed in the manner it would be to a user who is charged with chronicling information associated the particular healthcare interaction. The user may selectively control the I/O device 110 to select a preview option within the generated user interface. Data representing the at least one electronic form including all selected form control data objects is provided from the form control processor 102 to the preview processor 108. The preview processor 108, in response to detecting the type of healthcare interaction associated with the at least one electronic form, executes instructions that uses the layout of the electronic from the formatting grid to generate a preview of the form. The preview processor 108 provides the form preview data to the UI generator to generate a form preview UI for display on the display device 112. This advantageously enables the user creating the form to visually inspect the created form as well as utilize the respective form control data objects within the form to ensure that the form will be able to receive data entry from the healthcare professional charged with performing the particular healthcare interaction with the patient. The user may selectively exit the preview mode resulting in the form creation UI generated by the form processor 102 to be displayed on the display device 112. This allows for at least one of (a) reconfiguration of form control data objects; (b) addition of new form control data objects and (c) deletion of form control data objects from the form.

Once the form has been created, a user may save the created form in the repository 104 and the saved form in the repository 104 may be selectively accessed by another device that may be used by the healthcare provider when chronicling information about the particular interaction. In one embodiment, a healthcare provider may use a portable computing device executing a set of instructions that allow for user data entry of information associated with the healthcare interaction. The portable computing device my access the repository 104 and select the user created form which enables the provider to input desired information as required by the form control data objects of the at least one electronic form. In another embodiment, the portable computing device may be directly provided with data representing the user created form to allow a user to input the desired data.

Turning now to FIG. 2 which illustrates an exemplary display image 200 generated by the UI generator 106 in response to instructions from the form processor 102. The elements of the display image 200 and the hardware that control the generation thereof will be discussed using the component elements of FIG. 1. The display image 200 described herein includes a set of exemplary features available when using the form building apparatus 100 from FIG. 1 and describe an exemplary implementation thereof. The features, images and image elements described below are described for purposes of example only and the form building apparatus may generate other images or image elements as needed for implementing the features discussed below. Throughout the following description, the term “user” is intended to refer to the party using the form building apparatus 100 to create the electronic form whereas the term “provider” is intended to refer to the party who uses the completed form during the healthcare interaction for entering particular information items therein. However, this is described for purpose of example only and these terms can be used interchangeably such that a provider may both create and use the completed form and the user may also create and use the complete form to enter information items therein.

The display image 200 includes a form control section 210. The form control section 210 includes at least one user selectable form control image element 212a, 212b . . . 212n. each of the at least one user selectable form control image elements 212 may include a form control name 214a, 214b . . . 214n and a form control type 216a, 216b . . . 216n. As shown herein n may represent any positive integer. Collectively the form control image elements will be referred to using reference numeral 212, the form control name will be referred to using reference numeral 214 and the form control type will be referred to using reference numeral 216. Respective form control image elements 212 may be visual indicators of form control data objects which are coded applications that provide executable instructions enabling a user to enter a respective type of information that may be associated with a particular type of healthcare interaction between the patient and provider. Thus, any description of a form control image element 212 should be understood to include the underlying form control data object and instructions that enable operation thereof. The form control image element 212 includes a form control name 214 that describes what information is able to be collected using the particular form control image element. Additionally, the form control image element 212 includes a form control type 216 that represents the manner in which the information may be entered into the resulting form via the form control image element 212. The form control type may include any of (a) a drop down box that presents a candidate set of information able to be selected by a user; (b) a selection box (e.g. check box) indicating the presence or absence of information; and (c) a free form tool enabling alphanumeric entry of information by the user. In another embodiment, the type of form control element may include an exclusivity form control element which may present the user with a plurality information items describing an aspect of the healthcare interaction. The exclusivity form control element enables the user to select only a respective one of the plurality of information items. By enabling selection of only a single information item, the system automatically de-selects any previously selected information item.

The form control image elements 212 present in the form control section 210 of the display image are automatically populated by the form processor 102. The form processor 102, in response to receiving an input signal representing a type of healthcare interaction for which information is being chronicled or otherwise recorded, queries the repository 104 for all form control data objects and their respective image elements that are associated with the type of healthcare interaction. This query results in selection of a set of candidate form control image elements 212a-212n associated with the particular type of healthcare interaction from the repository 104. The form processor 102 provides data representing the candidate form control image elements to the UI generator 106 for inclusion in the form control section 210 of the display image 200.

The display image 200 further includes a formatting grid 220. As shown herein the form control section 210 and formatting grid 220 are positioned adjacent one another advantageously enabling quick selection and movement of form control data objects for positioning within the formatting grid 220 in the manner discussed below. However, the layout on the screen is described for purpose of example only and these sections may be coded to be positioned in any orientation or arrangement capable of enabling selection and dropping of an object from the form control section 210 at a position within the formatting grid 220.

The formatting grid 220 includes a number of columns 222 and a number of rows 224 in which a user may selective position a form control image element 212 located in the form control section 210. The columns 222 and rows 224 of the formatting grid 220 enable a user to selectively position different form control image elements 212 therein and provide a layout of the form being created by the form building apparatus 100. A divider 223 is positioned between adjacent columns to selectively provide a space between the columns 222a and 222b. In one embodiment, the divider 223 may include an indicator in each row 224 representing the row number. The columns 222 and rows 224 represent discrete positions within the form that will be created. A form control image element 212 may be selected and dragged over a respective row 224 within a respective column 222 and deposited therein. Once in the desired position, information associated with the form control image element 212 is automatically populated within the row 224 and column 222 as will be discussed below. As shown herein the formatting grid 220 includes two columns 222a and 222b and seven rows 224a-g. However, this is shown for purposes of example only and the formatting grid 220 may include any number of columns 222 and/or rows 224. Additionally, while a single divider 223 is shown for providing a space between column 222a and 222b, one skilled in the art will appreciate that other dividers 223 may be shown in the formatting grid 220 depending on the number of columns 222 in the formatting grid. In another embodiment, a row divider may be selectively positioned between adjacent rows to provide a predetermined amount of space therebetween. In this embodiment, there may be a row divider between each adjacent row. Alternatively, there may be a row divider positioned between one set of rows but not others. The spacing and format of the columns and rows is selectively controlled by the user when the form creation process is started.

Positioned at each row and column is a respective form control cell 226 able to receive a respective form control image element 212 therein. In the exemplary display image 200, there are fourteen (14) form control cells 226. However, this is shown for purposes of example only and the number of form control cells 226 present in a given display image 200 is based on the number of rows 224 and columns 222 present in the formatting grid 220.

The form control cell 226 includes a name section 230, a data input section 232 and an editing section 234. In response to dragging and dropping of a respective form control image element 212 into the form control cell 226, aspects of the form control data object represented by the form control image element 212 are positioned within the different sections of the form control cell. Data representing the form control name 214 displayed in the image element 212 is automatically populated in the name section 230 of the form control cell 226. A form control type indicator corresponding to the form control type 216 associated with the form control image element 212 is automatically populated in the data input section 232. Depending on the type 216 of form control associated with the form control image element 212, a different representation may be present in the data input section 232. For example, if the type of form control is a drop down box, an image representing a drop down box may be presented in the data input section 232. Alternatively, if the type of form control is a selection box, an image representing a box in which a check mark or “x” may be provided by a user is presented in the data input section 232. In another embodiment, if the type of form control is a free form control, an image representative of a blank box in which alphanumeric characters may be input by a user may be provided in the data input section 232.

In exemplary operation, a user may engage the I/O device 110 to select at least one form control image element 212 listed in the form control section 210. Selection results in the user being able to drag the selected form control image element 212 and position the selected form control image element in a respective form control cell 226. The selected form control image element 212 remains in the form control section 210 but the visual appearance of the selected form control image element 212 is modified to indicate that the element has been selected and placed within the form. Once positioned, the form processor 102 parses the underlying data object of the selected form control image element 212 stored in the repository 104. The form processor 102 derives data representing the form control name 214 and form control type 216 from the object stored in the repository 104. The form processor 102 also populates the name section 230 with data representing the name of the selected form control 214 and the data input section 232 with data representing the type of form control 216. Additionally, the form control processor 102 determines if the selected form control image element 212 may be edited or otherwise modified by a user. If the selected form control image element 212 may be edited/modified by a user, the form processor 102 automatically populates an editing section 234 with at least one user selectable image element enabling the user to edit an aspect of the form control image element 212. As used herein, a form control image element 212 may be editable if there are multiple different types of information that a user may select as part of inputting data about the healthcare interaction.

In one embodiment, the form processor 102 may determine that the form control image element 212 in form control cell 226 is a drop down image element that presents a set of candidate information items that may be selected by a user. In this embodiment, items of information that are to be included in the set of candidate information items provided in the drop down box image element may be chosen by the user. In this instance, an information editing image element 236 may be selected by the user. Upon selection thereof, the form processor 102 causes the UI generator to generate a second window that may contain all available information items able to be selected. The user may choose which of the available information items are to be included as the set of candidate information items for the associated dropdown box image element. The form processor 102 receives inputs from the user identifying the information items and automatically assigns the set of candidate information items to the form control image element 212 in the form control cell 226. Thus, when the form is operational, a provider looks to select an information item associated with the form control element 212, the provider will only be presented with the set of candidate information items determined by the form's creator.

In another embodiment, where the form control image element 212 is a selection box image element, the form processor 102 may similarly cause the UI generator 106 to generate an editing image element 236 and populate the editing section 234 therewith. In this embodiment, selection by a user of the editing image element 236 may result in the form processor 102 controlling the UI generator 106 to generate a second window with a set of candidate information items that may be selected for inclusion within the data input section 232. A user may choose from the available information items to create the set of candidate information items and the form processor 102 may automatically associate selection boxes with each of the candidate information items in the data entry section 232. For example, a user may select three different information items in the editing window and, in response thereto, the form processor 102 controls the UI generator to display the three selected information items having respective selection boxes associated therewith. This advantageously enables the use to identify the presence or absence of the respective information item associated with the particular healthcare interaction.

In an embodiment, where the form control image element 212 is a free form tool able to receive alphanumeric input from a provider, the form processor 102 controls the UI generator to generate an editing image element 236 that selectively enables a user to set at least one parameter associated with the free form tool. Parameters able to be set may include but are not limited to (a) max number of characters able to be input; (b) min number of character required to be input; (c) font type; (d) font size control; and (e) font color.

Referring back to the query by the form processor 102 regarding the selected form control image element, the form processor 102 may also determine stage information associated with the selected form control image element. Stage information may represent a different time period or aspect associated with the particular healthcare interaction with which the selected form control element 212 is associated. In the event that the particular healthcare interaction has multiple stages or time periods associated therewith, the form control processor 102 controls the UI generator 106 to generate a stage selection image element 238 and automatically populate the editing section with the stage selection image element 238. Selection of a respective one of the stage selection image elements causes the form processor 102 to mark the selected form control image element as mandatory requiring a user to enter an information item associated with the form control image element 212. In one embodiment, by selecting the stage selection image element 238, the form processor 102 modifies the display of the selected image control element 212 in the resulting form being created. This advantageously provides the provider who is completing the form with a visual cue that notifies the provider that an information item must be specified for that form control image element.

Display image 200 further includes a grouping image element that, in response to selection thereof, enables a user to define a set of form control elements 212 in respective form control cells as a group of related form control elements.

Selection of the grouping image element 240 results in the form processor 102 controlling the UI generator 106 to modify the selection cursor within the display image 200 allowing the user to select multiple form control image elements 212 in different form control cells 236 as part of a group. Once a set of form control image elements 212 are grouped together, the form processor 102 notes the grouping and ensures that, in the complete form, each selected form control element 212 of the group is displayed together in a defined area within the completed form. The grouping function may be implemented multiple times within the same form enabling the user to define multiple groups of form control image elements 212 in a given form.

The display image 200 further includes a removal section 242. During design and layout of a given form, it may be determined that a previously selected form control image element in a form control cell 236 is not needed or otherwise unwanted. A user may engage the I/O device to select the form control cell 236 including the unwanted form control image element 212 and drag the selected unwanted form control image element 212 to within the removal section 242. Upon de-selecting the unwanted form control image element 212 after dragging to the removal section 242, the unwanted form control image element 212 and any edits associated therewith are removed from the form. Once removed from the form, the visual depiction of the removed form control image element 212 within the form control section 210 is modified to notify the user that the respective form control image element 212 is available for reselection and positioning within the format grid 220.

Display image 200 further includes an auxiliary section 244. The auxiliary section 244 displays image elements representing respective types of auxiliary information that may be associated with one of (a) the particular healthcare interaction for which the form is being designed; and (b) at least one form control image element positioned within a form control cell 236. Auxiliary information may include any documentation or other set of information that may be useful to the provider who will be completing the form. In one embodiment, a first auxiliary information image element 246a may be automatically populated within the auxiliary section 244 in response to selection of the particular healthcare interaction at the outset of building the form. The form processor 102 queries the repository 104 in response to inputting the particular healthcare interaction and, in addition to acquiring all form control image elements 212 as discussed above, the form control processor 102 automatically acquires any auxiliary information associated with the particular healthcare interaction and associates that auxiliary information with the form being created. The form processor 102 controls the UI generator 106 to generate a corresponding first auxiliary information image element 246a in the auxiliary section 244. In another embodiment, in response to selecting a respective one of the form control image elements 212 from the form control section, a second auxiliary information image element 246b may be automatically populated within the auxiliary section 244. In this embodiment, the form processor 102 parses the form control data object data in the repository 104 when a respective form control image element is selected to identify if there is any auxiliary information associated therewith. If there is auxiliary information associated therewith, the form processor 102 retrieves the auxiliary information and associates it with the form being created. The form processor 102 controls the UI generator to generate a corresponding first auxiliary information image element 246b in the auxiliary section 244.

The display image 200 also includes a formatting section 249 that includes multiple user selectable image elements enabling the user to define parameters associated with different sections of the form being created. The formatting section 249 may include a grid format section 250. The grid format section 250 includes at least one type of image element enabling a user to define at least one parameter associated with the formatting grid 220 and the respective cells 236 and dividers 223 present therein. As shown herein, a first grid format control 252a enables a user to selectively define the number of columns and/or rows to be included in the formatting grid 220. By setting the number of columns and/or rows, the user creating the form is advantageously able to define the number of form control cells 236 that will be present in the form. A second grid format control 252b enables a user to selectively define the height and/or width of the columns and/or rows. In one embodiment, this may be accomplished by providing the user with a ratio of pixel height and pixel width of a column and row in the column. A third grid format control 252c enables the user to selectively define the width, in terms of pixels, of the divider 223. In another embodiment, the third grid format control 252c may also enable the user to selectively position dividers at various points within the formatting grid as needed. These formatting controls employed are described for purposes of example only and any number of image elements enabling the user to selectively control, set and/or define any parameter associated with the format of the formatting grid 220 and resulting form created thereby may be included.

The formatting section 249 (which may be embodied as a ribbon) further includes an auxiliary formatting section 254. The auxiliary formatting section 254 includes at least one user selectable image element 256 enabling the user to define at least one parameter associated with the number and type of auxiliary information that may be included within the auxiliary information section 244. In one embodiment, the auxiliary formatting image element 256 enables the user to selectively define the width, in terms of pixels, of the auxiliary information section 244. In another embodiment, the auxiliary formatting image element 256 in the auxiliary formatting section 254 may include a text control option that allows the user to selectively determine whether any text should be wrapped allowing it to continue to the next line or be truncated at the end of a single line. The formatting section 249 may also include an attribute formatting section 258 including at least one attribute formatting image element 260 that defines an attribute associated with at least one form control image element or group of form control image elements. In one embodiment, the attribute formatting image element 260 may enable the user to selectively define a respective form control image element or group thereof as one of “active” enabling a user to interact and enter an information item associated therewith or “read only” which would prevent a user from entering information therein.

The display image 200 may also include a mode selection section 262 that allows the user to selectively switch between a form creation mode by selecting the form mode image element 264 and a preview mode by selecting the preview mode selection image element 266. The activity described above of laying out and defining which form control image elements and associated auxiliary information are to be present in a respective electronic form occur during form creation mode. Once the electronic form has been created and includes all desired form control image elements, the preview mode may be activated by selecting the preview mode image element 266. This results in data representing the created form being provided to the preview processor 108 by the form processor 102. The preview processor 108 automatically detects the type of form and type of healthcare interaction with which the form is associated and executes instructions to render the form as it would be seen by the healthcare provider charged with filling out the electronic form. This advantageously enables the user to view the completed form and test whether or not all of the form control image elements within the form operate as intended. The user may exit preview mode by activating an exit from preview image element. Alternatively, the user may exit the preview mode by activating the form building mode image element 264.

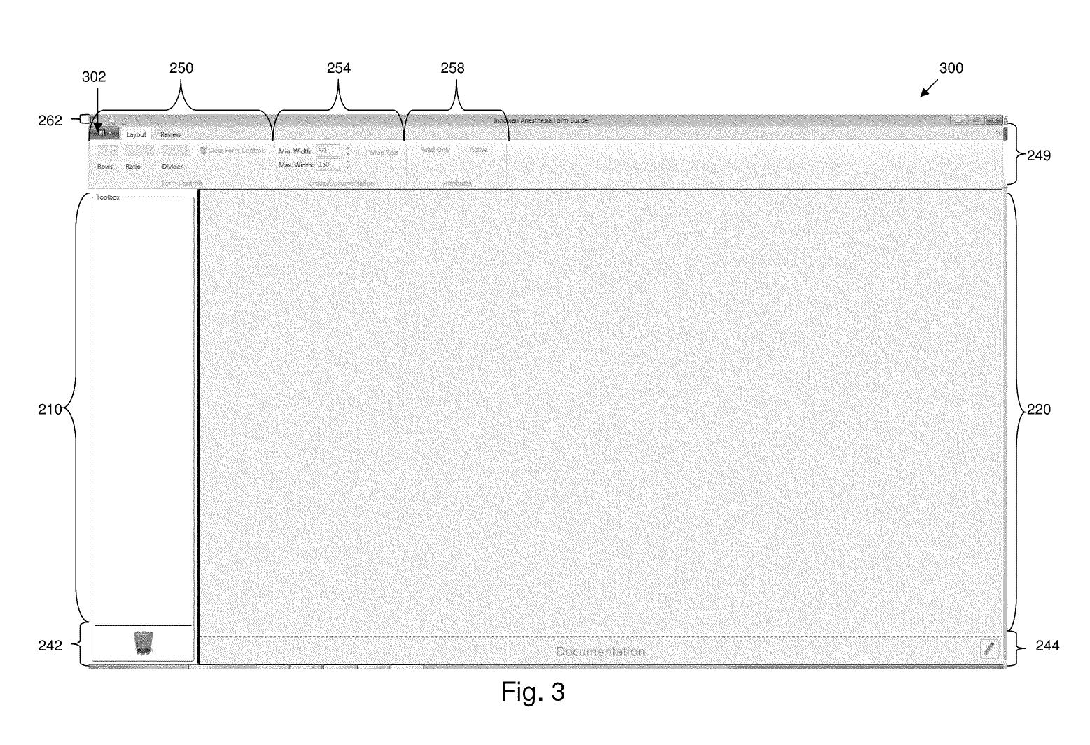

An exemplary implementation of the form building apparatus described above in FIGS. 1 and 2 will now be further described with respect to FIGS. 3-20. FIGS. 3-20 provide exemplary display images 200 generated by the UI generator 106 under control of one of the form processor 102 and preview processor 108. The display images of FIGS. 3-20 represent an exemplary process in creating an electronic form for chronicling patient data associated with the particular healthcare interaction of providing anesthesia to a patient undergoing a surgical procedure. Once the electronic form is designed and saved, data representing the completed form may be used by a provider at the point of care (e.g. providing anesthesia to the patient). Data representing the completed electronic form may be used via a dedicated apparatus or computing device able to display the completed form and receive user data entry for any of the form control data objects within the created form. The particular application that enables user data entry of information items associated with the form control data objects and the particular healthcare interaction are not germane to the present invention. Rather, the present invention provides the dynamic form building apparatus 100 used to design, create and otherwise build the form in which the information items will ultimately be entered by the provider. The following description may utilize reference numerals relating to the general structure and format of the display image as set forth in FIG. 2.

FIG. 3 is an exemplary display image 300 generated by the UI generator 106 prior to a user initiating the form creation process of the form building apparatus. Similarly to display image 200 in FIG. 2, display image 300 includes a form control section 210 in which form control image elements will be displayed once the healthcare interaction (e.g. administration of anesthesia) is selected. Adjacent the form control section 210 is the formatting grid 220 in which form control image elements may be selectively positioned. However, as shown herein the formatting grid 220 is blank because the form generation process has not yet been initiated by the user. The display image 300 further includes the formatting section 249 and associated grid format section 250, auxiliary format section 254 and attribute format section 258. The mode selection section 260 is also provided in display image 300. Adjacent to the form control section 210 is a removal section that enables a user to remove a respective form control image element from within the formatting grid 220. Additionally, display image 300 further includes the auxiliary information section 244 positioned adjacent to the format grid 220. Each of the sections described herein may include any image element or information item discussed in FIG. 2. The following description represents one example of a form creation process executed by the form building apparatus 100.

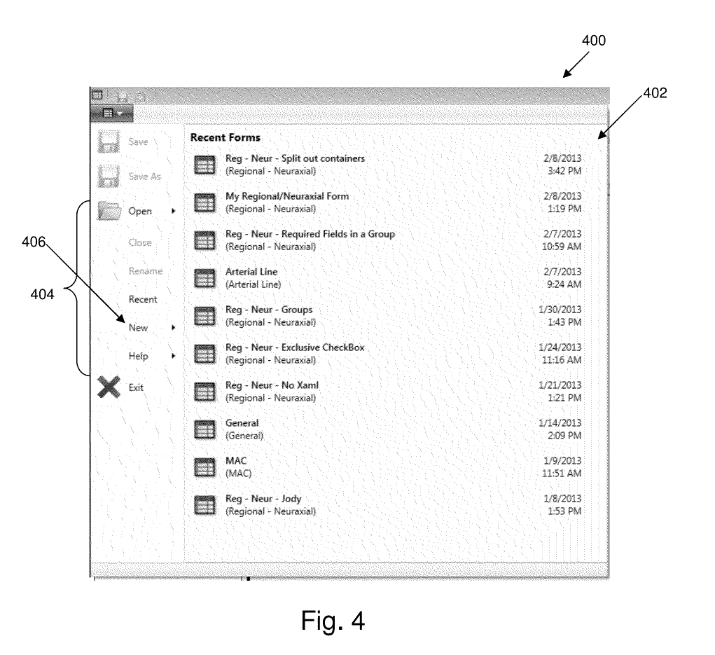

When a user wishes to initiate the form generation process, an initiation icon 302 is activated by the user using the I/O device 110. Activation of the initiation icon 302 results in the form processor 102 controlling the UI generator 106 to generate the display image 400 in FIG. 4. Display image 400 may be a separate window from display image 300 in FIG. 3 and displayed on top of display image 300 as is commonly known when opening a dialogue box that requires user action. In display image 400, the UI generator 106 generates data representing a selection window 402. The selection window 402 may be populated with a predetermined set of user selectable image elements representing electronic forms associated with particular healthcare interactions. In this embodiment, where the form building apparatus is being used to generate an electronic form for use in chronicling patient data associated with providing anesthesia to the patient, the set of electronic forms present in the selection window 402 represent different electronic forms for chronicling different methods and/or techniques for administering anesthesia to a patient. In another embodiment, the selection window 402 may be populated with a set of image elements representing electronic forms designed by a particular user/healthcare provider. For example, the image elements could list a set of electronic forms for different modes of administering anesthesia to a patient all of which were created by the same anesthesiologist. In another embodiment, if this is the first time the form building apparatus is being used, the selection box 402 may be empty. In this embodiment, a user can select navigation controls 404 enabling one of (a) creation of a new electronic form 406 and (b) navigating to a location at which previously created electronic form data may be stored (e.g. the repository 104).

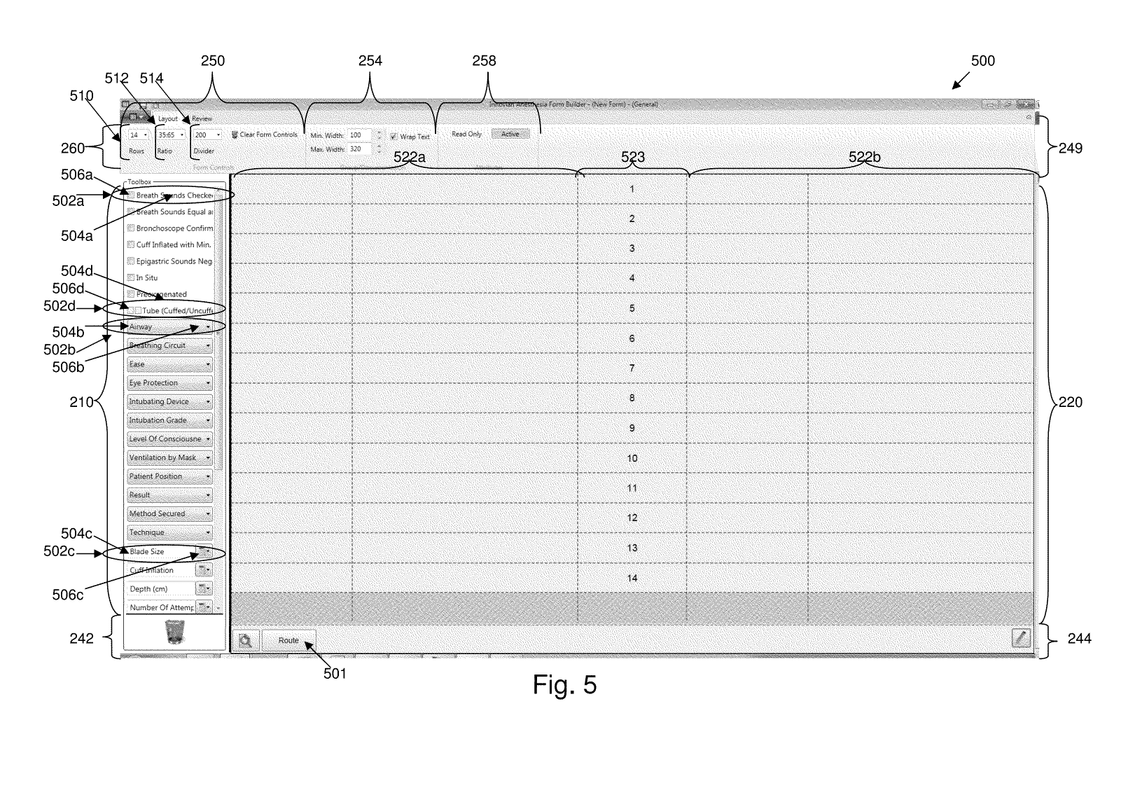

The following description of system operation is based on a user choosing to create a new form. To do so, the user activates the new form image element 406 and selects an image element representing a particular healthcare interaction 408, in this case, administration of general anesthesia. These selections result in display image 400 being closed and result in UI generator 106 generating display image 500 as shown in FIG. 5.

Display image 500 of FIG. 5 is a modified version of display image 300 shown in FIG. 3. Thus, the common structural sections of the display image 500 are the same as those discussed above in FIG. 3. To generate display image 500, the form processor 102 receives input representing the healthcare interaction of “general anesthesia” and queries the repository 104 for all form control data objects that enable a provider to input at least one information item associated with administering general anesthesia to a patient. Data representing the resulting form control data objects are provided in the form of form control image elements from the repository 104 to the UI generator 106 which populates the form control section 210 in display image 500 with a set of form control image elements that, once positioned within an electronic form, enable user data entry of information items associated with administering general anesthesia to the patient. As can be seen herein, each form control image element in the form control section includes information describing the enterable information item associated therewith and the type of form control data object it will represent when placed in electronic form.

There is a plurality of different form control image elements present in the form control section 210. The following will provide a general description of the different types of form control elements to indicate how they are display to the user creating the form. A first form control image element 502a includes description information 504a describing the information enterable via the first form control element 502a. In embodiment information to be entered relates to “breath sounds checked”. The first form control element 502a further includes a “check box” which represents the type of form control data object used to enter information. In this instance, the form control data object 502a enables a user to enter information indicating that the provider has checked the breath sounds of the patient. As can be seen, this exemplary description includes a plurality of first form control image elements each having a unique information description associated therewith along with the “check box” which indicates that the described information is enterable (or selectable) by a provider via an interactive check box within the form.

A second form control image element 502b is also present within the form control section 210. Similarly to the first form control image element 502a, the second form control image element 502b includes description information 504b identifying the information enterable via the second form control image element 502b. The second form control image element 502b is represented as a drop down box 506 that indicates that the information enterable via the second form control image element 502b may be completed using a drop down box that presents a provider completing the form with a candidate set of information items that may be selected and entered into the electronic form. This exemplary second form control image element 502b describes information associated with the patient's airway and that any information item that describes the patient's airway may be selected from via a drop down box that includes a candidate set of information items used in describing the patient's airway.

A third form control image element 502c is further shown in the form control section 210. Similarly to the first and second form control image elements 502a and 502b, the third form control image element 502c includes description information 504c identifying the information enterable via the third form control image element 502c. The third form control image element 502c is represented as a free form box 506c that indicates that the information enterable via the third form control image element 502c may be completed via alphanumeric character input. This exemplary third form control image element 502c enables a provider completing the form to enter alphanumeric characters that describes a blade size used during the procedure for which the anesthesia is being administered.

A fourth form control image element 502d is further shown in the form control section 210. The fourth form control image element includes description information 504d that identifies the information enterable via the fourth form control image element 502d. The fourth form control image element 502d is represented as an exclusivity selection element 506 that provides a user with a plurality of information items able to be selected but only allows a respective one of the plurality of information items to be selected at a given time. As shown herein, there the exclusivity selection element 506 includes two checkboxes only one of which may be selected by the user using the completed form. This exclusivity selection element 506 enables a user to specify whether the patient was cuffed or uncuffed during the administration of anesthesia.

The first, second and third image elements 502a-502c are described for purposes of example only and, as can be seen in the form control section 210, any particular healthcare interaction for which a form may be generated may include a plurality of different types of form control image elements that enable the user to enter different information items that describe an aspect of the particular healthcare interaction being chronicled.

Additionally, the form processor 102 may query the repository 104 for any auxiliary information associated with the healthcare interaction selected by the user. Any auxiliary information such as documentation about procedures that may be part of the selected healthcare interaction may be provided to the UI generator 106 which causes at least one auxiliary information image element 501 to be displayed within the auxiliary information section 244 of display image 500.

In order to create the form, the user may selectively use format control image elements present in the format control section 260 of display image 500. This exemplary display image 500 employs a predetermined number of columns 522a and 522b. This is shown for purposes of example only and the form building apparatus may enable a user to selectively define a number of columns to be present in the format grid 220. Other formatting parameters may be selectively controlled and/or defined using the formatting controls depicted in the format control section 260. A first format control image element 510 represents a first type format control that selectively enables a user to define and/or modify a number of rows present in the formatting grid 220. As shown herein, a formatting control that defines the number of rows is set equal to 14. A second format control image element 512 represents a second type of format control that selectively enables a user to define, in terms of pixels, the width of each row. For example, the ratio control changes a percentage of the width between the first column to the width of the second column and the percentage of the width of the fourth column to the percentage of the width of the fifth column. A third format control image element 514 represents a third type of format control that selectively enables a user to define and/or modify a width, in pixels, of a divider 523 positioned between the columns 522a and 522b. In one embodiment, the form processor 102 receives the input representing a number of rows from the first format control and inserts an indicator in each row of the divider 523 to identify the specific row number.

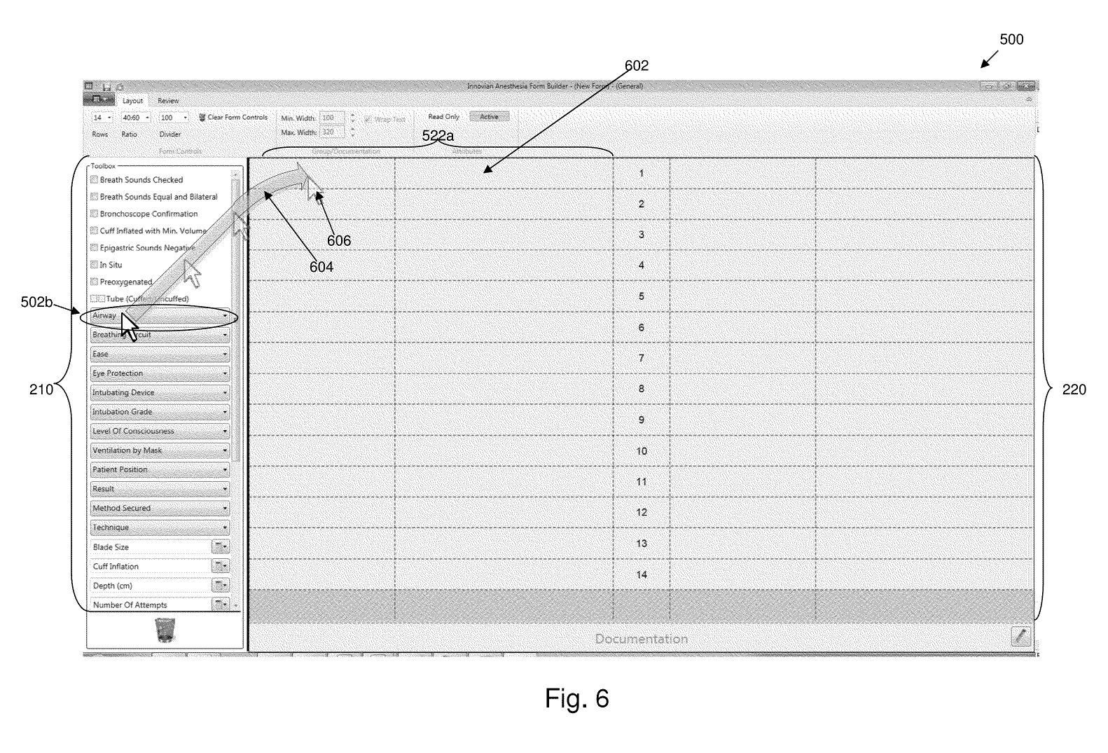

Once the form control data objects are populated in the form control section 210 and the parameters of the formatting grid 220 are defined, form creation can begin in earnest whereby users charged with creating the forms may selectively drag and drop form control image elements into various positions on the formatting grid 220. This process is illustrated in FIG. 6 which illustrates the selection of the second form control image element 502b (as described in FIG. 5 by a user using the I/O device 110. Once selected, the user may use the I/O device 110 to move the selected form control image element 502b into a desired position within the formatting grid 220. Since the formatting grid 220 is defined by columns and rows, each intersection of such is termed a form control cell which is represented by reference numeral 602. As shown herein, only a single form control cell is labeled, but it is understood that the number of form control cells in a given formatting grid is equal to the product of the number of rows and number of columns. In this instance, there are twenty eight (28) form control cells in which a form control image element selected from the form control section 210 may be deposited. The selection of the second form control image element 502 and movement thereof into form control cell 602 is depicted by the arrow labeled 604. The movement arrow 604 shows various positions of a cursor 606 as it traverses the display image 500 until the selected form control image element 502b is inserted into form control cell 602. Once positioned over or around the form control cell, the form control image element is automatically positioned within the boundaries of the form control cell. At any time, a user may re-select a form control image element in any form control cell and move the re-selected element to a different form control cell thereby enabling the user complete flexibility regarding the positioning of various form control data objects within the electronic form.

Furthermore, FIG. 6 merely represents one example of how a user may use an I/O device to select a form control image element and position the selected form control image element within the formatting grid at a desired position. It is readily understood that any number of form control image elements may be selected and positioned in the formatting grid so long as there is an available form control cell able to receive the object therein.

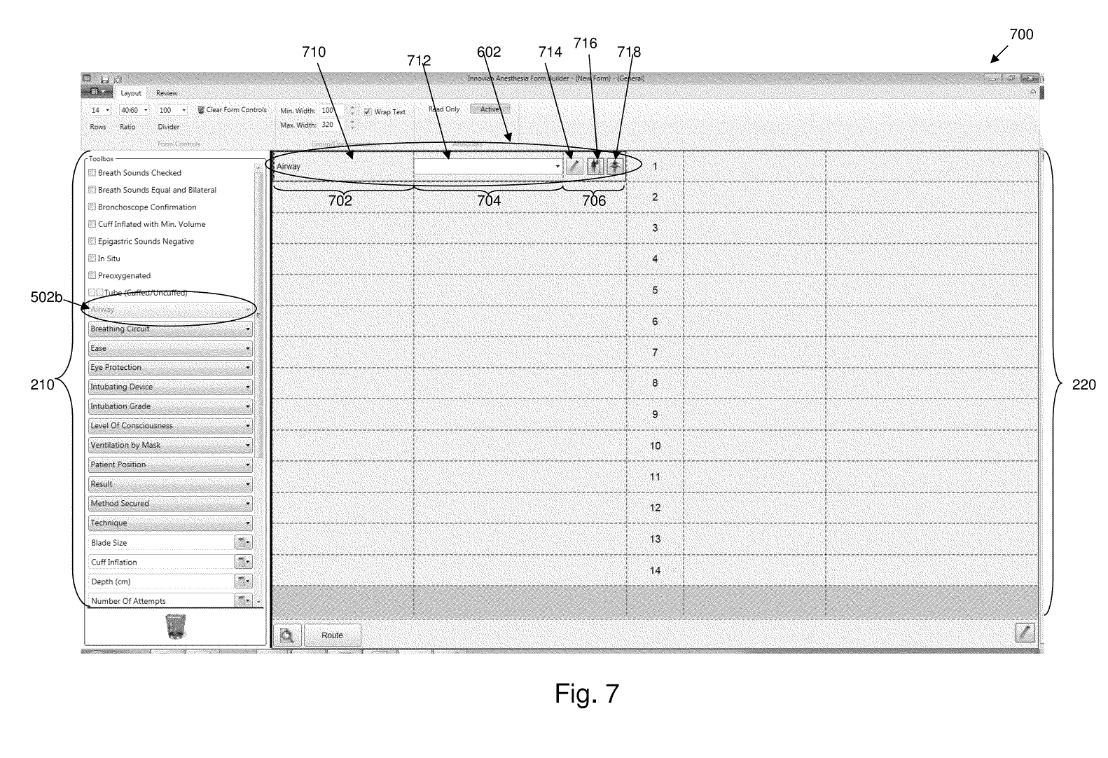

Turning now to FIG. 7 which depicts display image 700 that includes the selected form control image element 502b positioned in form control cell 602. Once positioned therein, the manner in which the form control image element 502b being displayed in the form control section 210 is modified. For example, the image element may be lighter in color or grayed out which advantageously indicates to the user creating the form that the form control is associated with this form but has already been positioned within a desired form control cell. Moreover, the form processor 102 actively prevents re-selection of the form control image elements from within the form control section 210 that have already been positioned within the formatting grid 220.

The form control cell 602 includes a name section 702, a data input section 704 and an editing section 706. This is similar to the description provided above in FIG. 2 and further description need not be repeated. When a user positions the form control image element 502b within the form control cell 602, the form processor 106 automatically parses the repository 104 to obtain the underlying form control data object. The form control processor 102 uses data associated with the form control data object to populate the various sections 702, 704 and 706. The form control processor 102 causes data representing the name of the form control data object 710, in this example, “Airway”, to be displayed in the name section 702. A representative image of the type and/or manner in which a provider may input information 712, in this example, a drop down box, is provided in the data input section 704. Furthermore, the form control processor 102 derives from the form control data object any customization or editable options associated therewith and automatically populates at least one of editing image elements 714, 716 and 718 within the editing section 706.

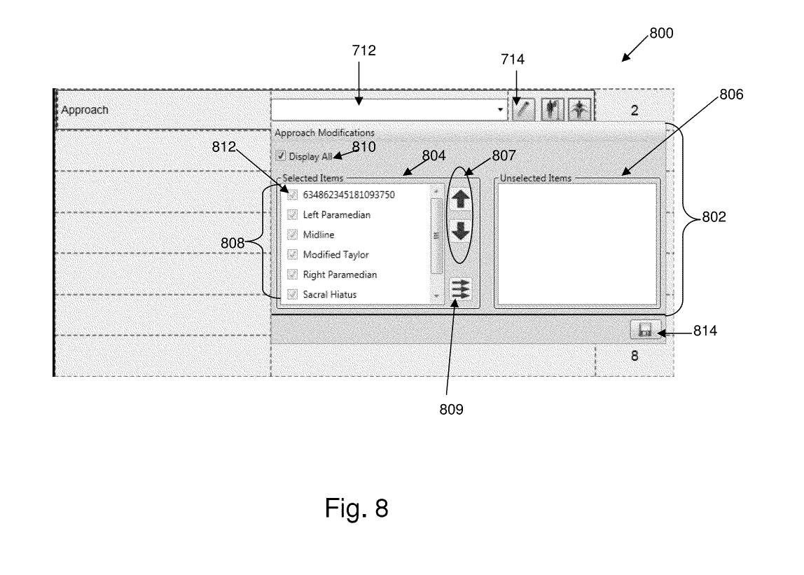

The editing image elements 714, 716 and/or 718 advantageously provide a user with the ability to selectively define parameters associated with the respective form control data object positioned in the form control cell 602. One example of a type of editing feature is shown in FIG. 8 which represents a display image 800 enabling definition of a candidate set of information items to be displayed within the drop down box 712 and selected as input by a provider completing the electronic form during the healthcare interaction of providing anesthesia.

Element 712 represents a data input editing function and activation thereof results in generation of a dialogue box 802 that may overlay display image 700 of FIG. 7. The dialogue box 802 provides a user creating the form with customization options allowing the user to specify what information items are to be displayed to a provider completing the form when the drop down box 712 on the complete form is activated. The dialogue box 802 includes a selected items box 804 that includes a set of all information items 808 selected to be displayed when the drop down box 712 is activated. Each information item within the set of information items 808 may include a check box 812 enabling individual selection or de-selection of the particular information item. A user creating the form may scroll through the set of information items 808 using navigation controls 807 which enable vertical scrolling of the set of information items thereby enabling the user to individually select or de-select information items as needed. When a user determines an information item within the set of information items 808 is not to be displayed, the user deselects (e.g. unchecks a checkbox) the undesired information item to be positioned in the unselected items box 806. If all selected items are desired to be unselected, use element 809. All items will be positioned in the unselected items box 806. To return the unselected information items in the unselected items box 806 back into the selected items box 804, a user need only to select the information item in the unselected items box via its associated checkbox and the information item is automatically moved from the unselected items box 806 into the selected items box 804. The user creating the form also has another option to include all information items by marking the display all items image element 810 as is shown herein. The ability to individually select information items is available when the all items image element 810 is unmarked thus enabling the user to navigate and select individual information items that are not needed to be moved into the unselected items box 806. Once complete, the user may assign the user-specified information items to the particular form control data object by activating the save function represented by the save image element 814.

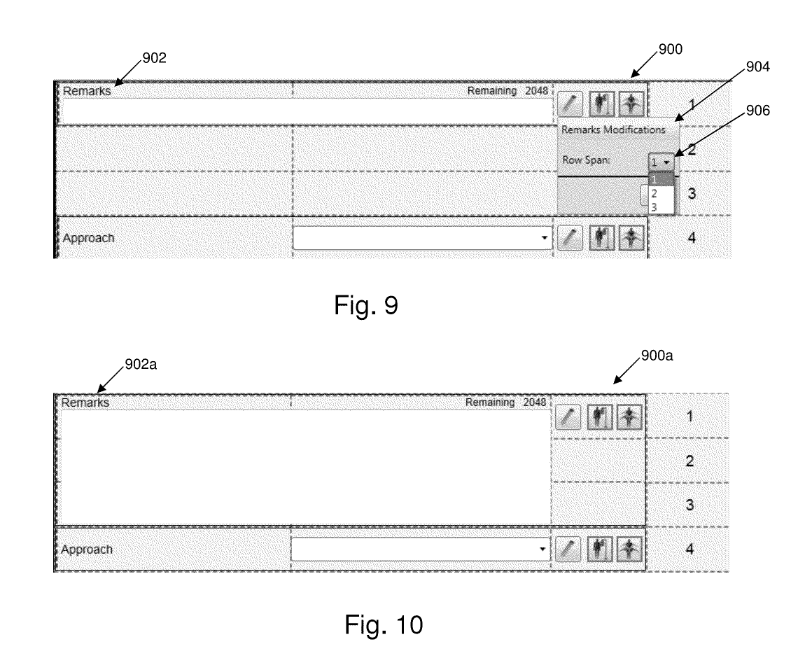

FIG. 9 provides another exemplary display image 900 that shows the operation of an editing function initiated by selecting editing image element 712 for a different type of data input mechanism. In this embodiment, the type of form control data object is a free form data entry object 902 enabling alphanumeric input of characters by the provider to complete the form. Activation of the editing element 712 results in opening of a configuration dialogue box 904. The configuration dialogue box 904 includes an image element representing a row selection tool 906. The row selection tool 906 enables the user to set the parameters associated with a number of rows within the formatting grid that the free form data entry object 902 will span. This advantageously enables the user creating the form to provide enough space for alphanumeric entry of an information item representing remarks about the particular aspect of the healthcare interaction. As shown in FIG. 9, the desired row control parameter is set as “row=3” using the row selection tool 906. Once the user defines the row parameters associated with form control data object 902, the form processor 102 uses that specified parameter to control the UI generator to modify display image 900a to include a modified form control data object 902a that spans 3 rows. This modified display image 900a is shown in FIG. 10.

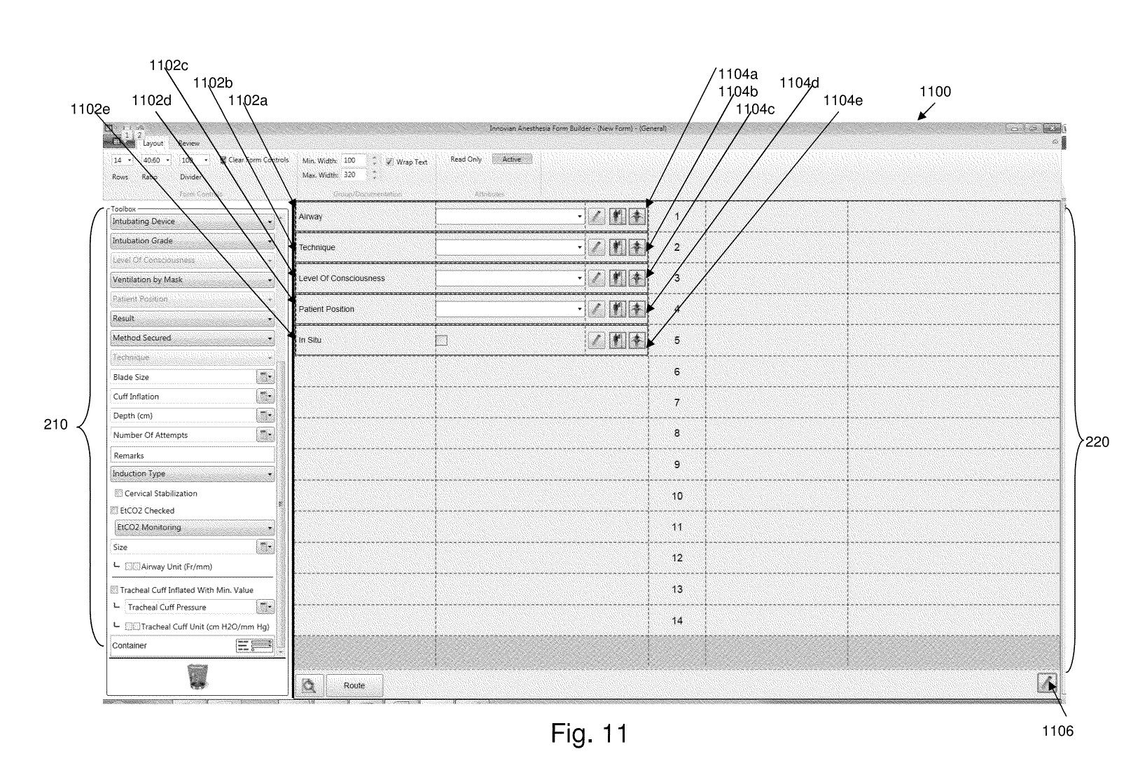

Another advantage provided by the form building apparatus is the ability to group a set of form control data objects together. A group of form control data objects may include form control data objects that are used to obtain information items related to a single aspect of the healthcare interaction. By grouping a set of form control data objects the form building apparatus advantageously will provide a visual grouping of these form control data objects such that a provider completing the form will understand that, information items associated with each of the form control data objects are to be entered in order to completely chronicle the particular aspect of the healthcare interaction. Grouping of a set of form control data objects may also be referred to as creating a container that sets the parameters associated with the grouped form control data objects. The container creation process and resulting grouping of form control data objects will be described below with respect to FIGS. 11-17.

FIG. 11 depicts an exemplary display image 1100 representing an in-progress form creation. At this point in the form creation process, a user has selected five form control data objects 1102a-1102e from the form control section 210 and dragged and dropped a respective one of the form control data objects 1102a-1102e into respective form control cells 1104a-1104e within the formatting grid 220. In this example, the first form control data object 1102a obtains an information item describing the patient's airway and uses a drop down box enabling user selection of the information item from a set of candidate information items. The second form control data object 1102b enables input of an information item describing the technique being used by the provider and similarly enables a user to select an appropriate information item from a drop down box including a set of candidate information items. The third form control data object 1102c enables input of an information item describing the patient's level of consciousness and the fourth form control data object enables input of an information item describing the patient's position. Similarly to the first and second objects 1102a and 1102b, the third and fourth form control data objects also enable input of the information item via a drop down box. The fifth form control data object 1102e enables the user to select whether or not the patient is “in situ” via a check box. Should the user wish to create a container for a number of further form control data objects, a container image element 1106 may be activated.

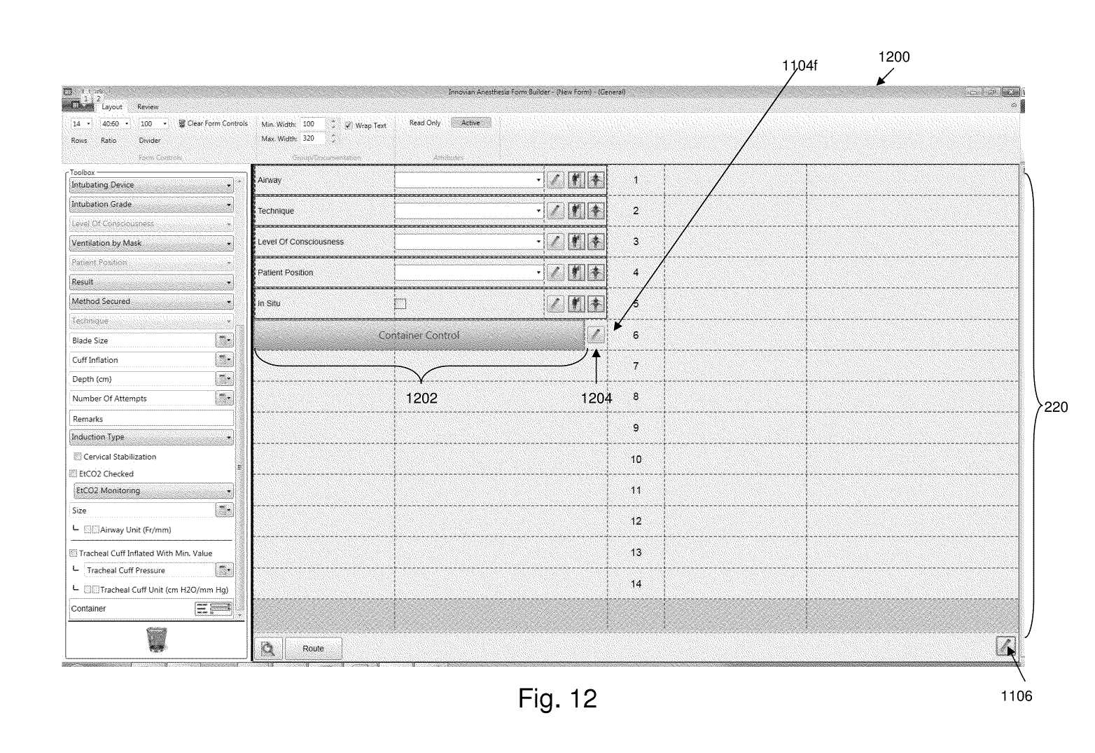

Once the container image element 1106 is activated, the resulting display image 1200, as shown in FIG. 12, is provided. In response to activation of the container image element, the form processor 102 automatically initiates the container creation algorithm and causes a container creation image element 1202 and associated container configuration image element 1204 to be automatically populated within a respective one of the format control cells 1104f. As shown herein, the form processor 102 may default to positioning the container creation image element 1202 within the next available row. However, this is discussed for purposes of example only and the container creation image element 1202 may be positioned in any available format control cell within the formatting grid 220. Additionally, the container control image element 1202 may be selectively repositioned within any available form control cell using the I/O device 110 in a manner similar to that discussed above with respect to positioning form control data objects from the form control section 210 within the form control cells in the formatting grid.

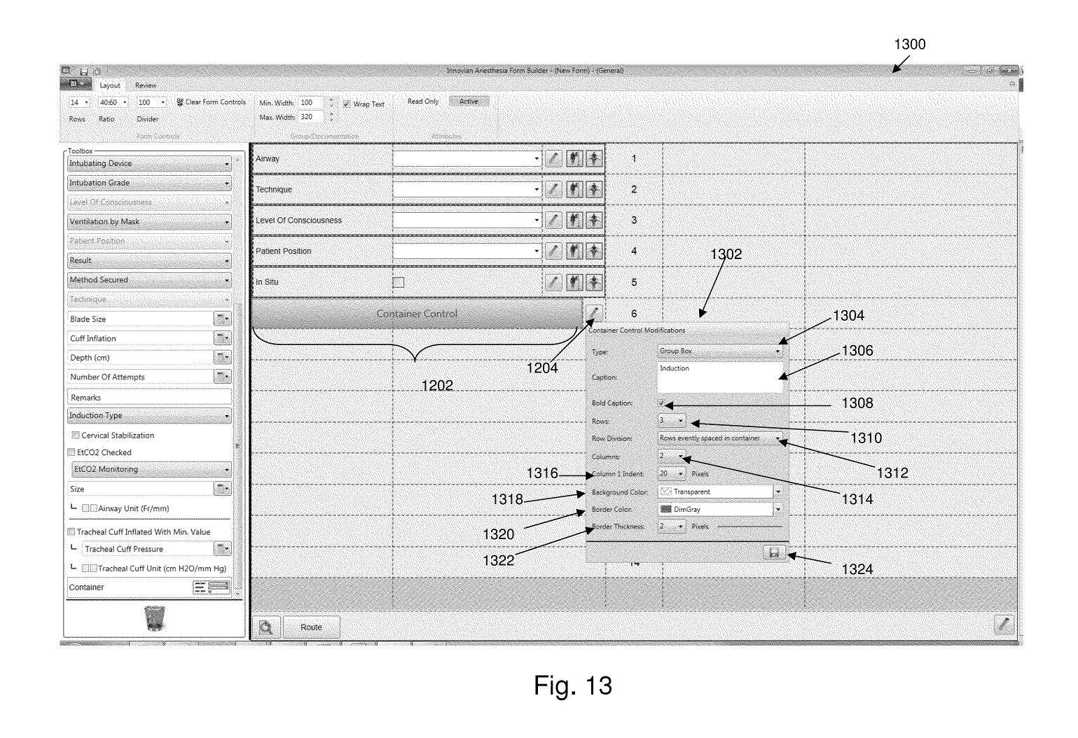

The parameters of the container may be selectively configured by the user creating the electronic form by activating the container configuration image element 1204. Activation of such results in display image 1300 of FIG. 13 being generated by the UI generator 106 in response to instructions from the form processor 102. Activation of the container configuration image element 1204 causes a container configuration dialogue box 1302 to be generated. The container configuration box 1302 includes a plurality of container configuration parameters 1304-1322 that are selectively definable by the user creating the form. Exemplary container configuration parameters may include at least one of (a) a container type 1304; (b) a container caption 1306 that describes the container being created; (c) a caption formatting option 1308 that selectively formats the container caption; (d) a container row selector 1310 for defining a number of rows (and form control cells) that are included within the given container; (e) a spacing parameter 1312 for defining the space between one of the number of rows and number of columns; (f) a container column selector 1314 for defining the number of columns within the container; (g)a column indent selector 1316 for defining an indent (in pixels) of each column from an edge of the container; (h) a background selector 1318 for selecting a color and/or type of background for the container; (i) a border selector 1320 for selecting a color or other attribute for use as a container border; and (j) a border thickness selector 1322 enabling definition of the thickness of the border for the container.

Each of the parameters 1304-1322 may be input by using any of a drop down box, free form alphanumeric input and a check box. For example, the container caption parameter 1306 is shown as being input via a free form alphanumeric text box. However, this is for purposes of example only and any manner of inputting and/or selecting a container caption may be provided. For example, the container caption parameter 1306 may be selected via a drop box that is pre-populated with a set of container caption labels that may be useful in formatting the electronic form for the particular healthcare interaction. Similarly, the row selector 1310 is shown herein as being defined using a drop down box. However, the row selection could be accomplished via a free form alphanumeric text box as well.

Once the parameters are configured, the user creating the form may select the save container image element 1324 and the parameters defined in the container configuration dialogue box 1302 will be used by the form processor 102 to control the UI generator in generating a corresponding display image including the container as defined by the container parameters.

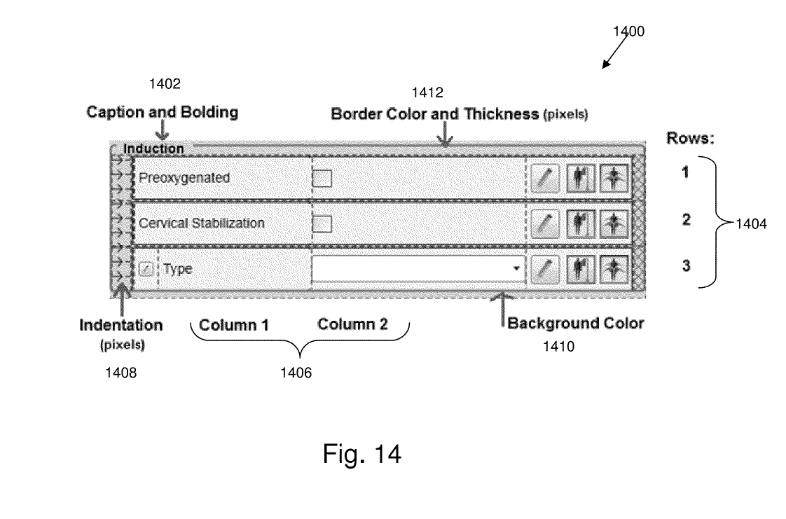

FIG. 14 is an exemplary display image 1400 of a container created using the container configuration process described in FIG. 13. Container display image 1400 depicts the section of the container to which the configuration parameters listed and described in FIG. 13 apply. As shown herein, the container display image 1400 includes parameters defining the caption for the container and any associated bolding 1402 which apply as defined using parameters 1306 and 1308, respectively from FIG. 13. The container display image 1400 includes three rows 1404 and two columns 1406 as defined by parameters 1310 and 1314, respectively. The indents 1408 are defined using parameter 1316. The user selected background color 1410 (in this instance-transparent) is defined by parameter 1318 in FIG. 13. Furthermore, display image 1400 includes the border color and thickness 1412 as defined by parameters 1320 and 1322 in FIG. 13.

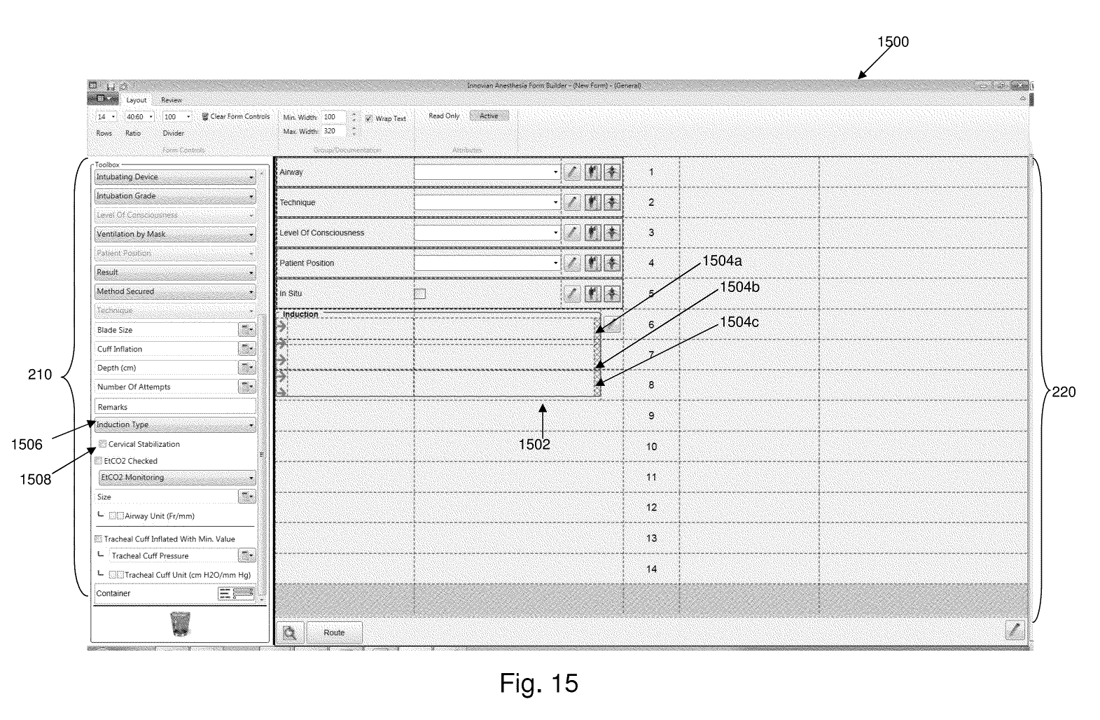

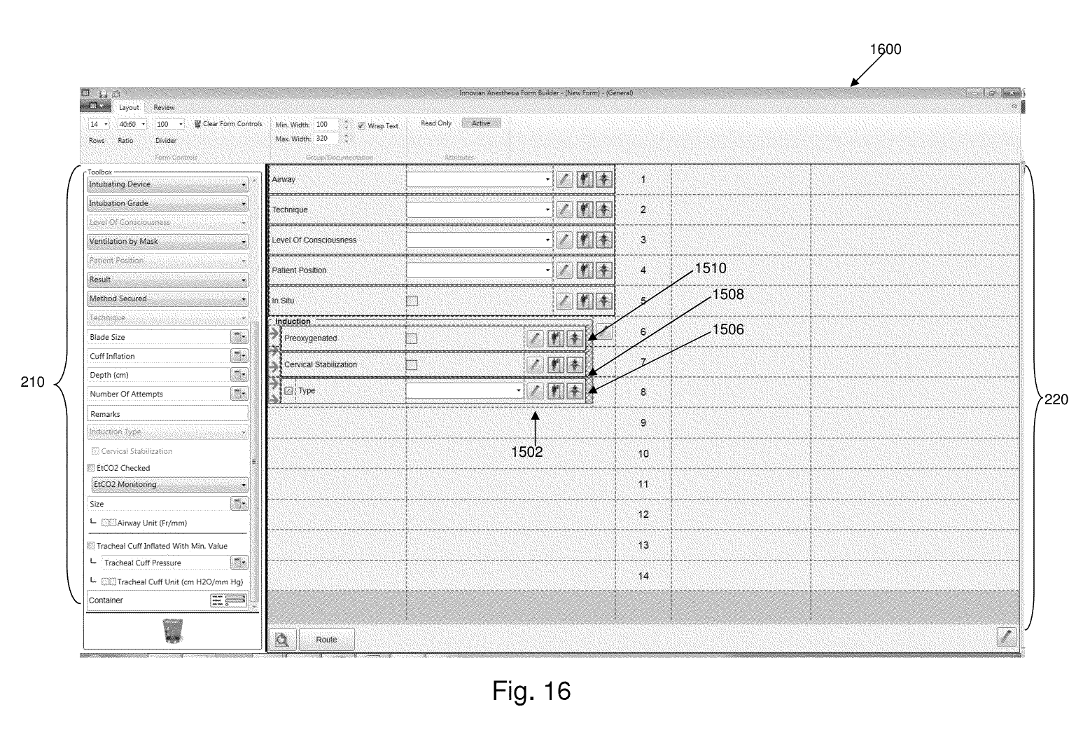

Turning now to FIG. 15 which depicts display image 1500 that includes a container 1502 positioned within the formatting grid 220. The container 1502 is entitled “Induction” and includes three form control cells 1504a-1504c in which form control image elements in the form control section 210 may be positioned. A user creating the form may select respective form control image elements from the form control section that are associated with inputting information about the aspect of the healthcare interaction related to an “induction”. This is described for purposes of example only and the form building apparatus enables the creation of multiple different containers each containing groups of form control data objects related to a particular aspect of the healthcare interaction. In this example, the induction type form control image element 1506 and cervical stabilization form control image element 1508 may be determined, by the user, to be positioned within respective cells 1504a-1504c of the induction container 1502. A user may engage the I/O device 110 to select one of the form control image elements 1506 and 1508 and drag them into a respective form control cell 1504a-1504c. The result of this operation is shown in FIG. 16 which provides display image 1600 that includes a container populated with certain form control data objects associated with form control image elements listed in the form control section 210. As shown in FIG. 16, the container 1502 includes the induction type form control data object 1506 and the cervical stabilization form control data object 1508. The container 1502 also includes a preoxygenated form control data object 1510 as well. The visual depiction of each of the form control image elements associated with these form control data objects within the form control section is modified to one of identify that the form control has been selected and prevent further selection of the form control data object from the form control section.

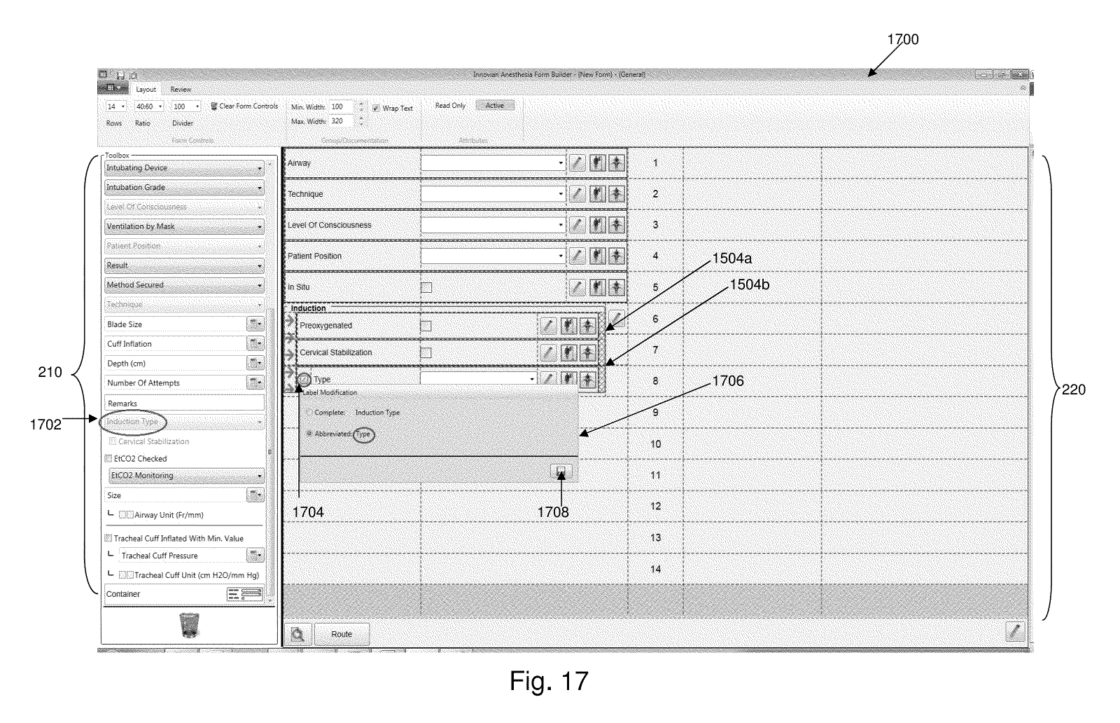

One exemplary embodiment wherein certain features of the form control data object may be modified is shown in FIG. 17. In this example, one of the selected form control data objects, the label induction type 1506 as shown in the circle labeled 1702, has been selected for inclusion within the container 1502. However, the container 1502 is captioned as “induction”. Thus, a repetition of the form control data object label 1702, “induction type” may be repetitive and distracting. In this instance, the form control data object 1506 may include a modifier image element 1704 results in the opening of a dialogue box 1706 that enables the user to selectively determine if the form control data object label should be abbreviated. In one embodiment, the dialogue box 1706 may provide the user with an option to display the complete object label of “induction type” or an abbreviated label of “type”. Alternatively, the dialogue box 1706 may include a free form text box enabling a user to specify their own abbreviation for the object label. The user may save these preferences using the save icon 1708 and the preferences will be automatically applied to the electronic form by the form processor 102.

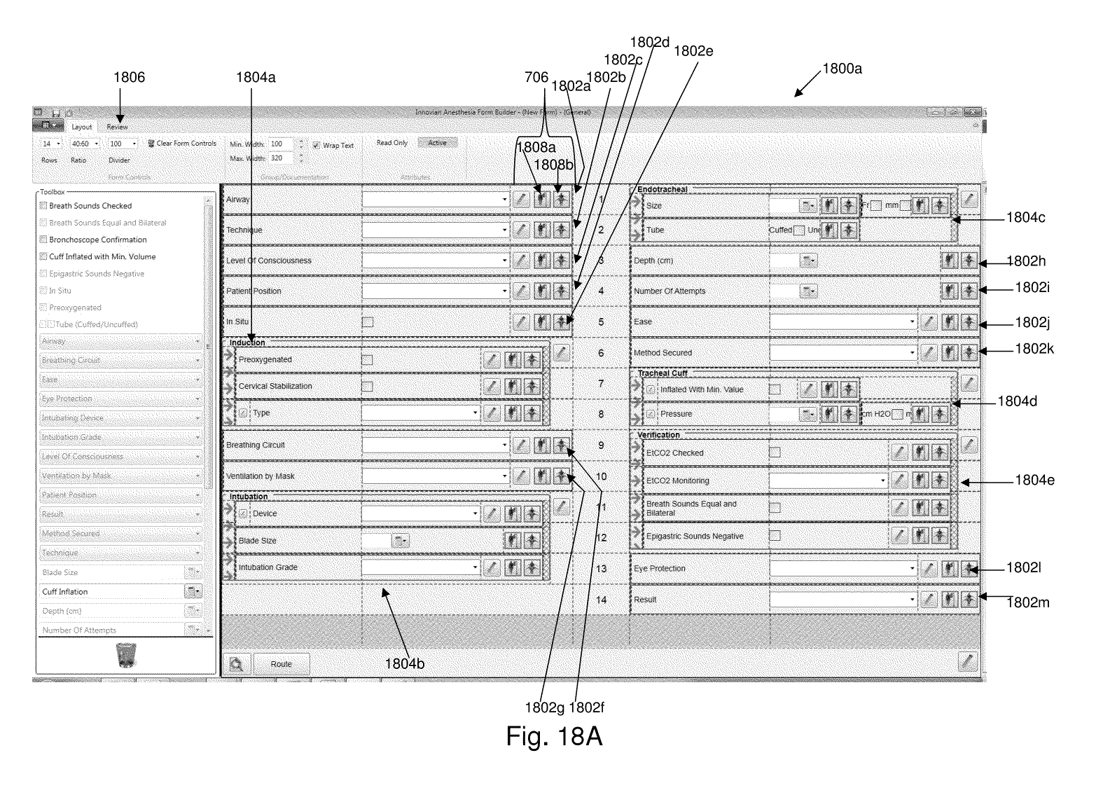

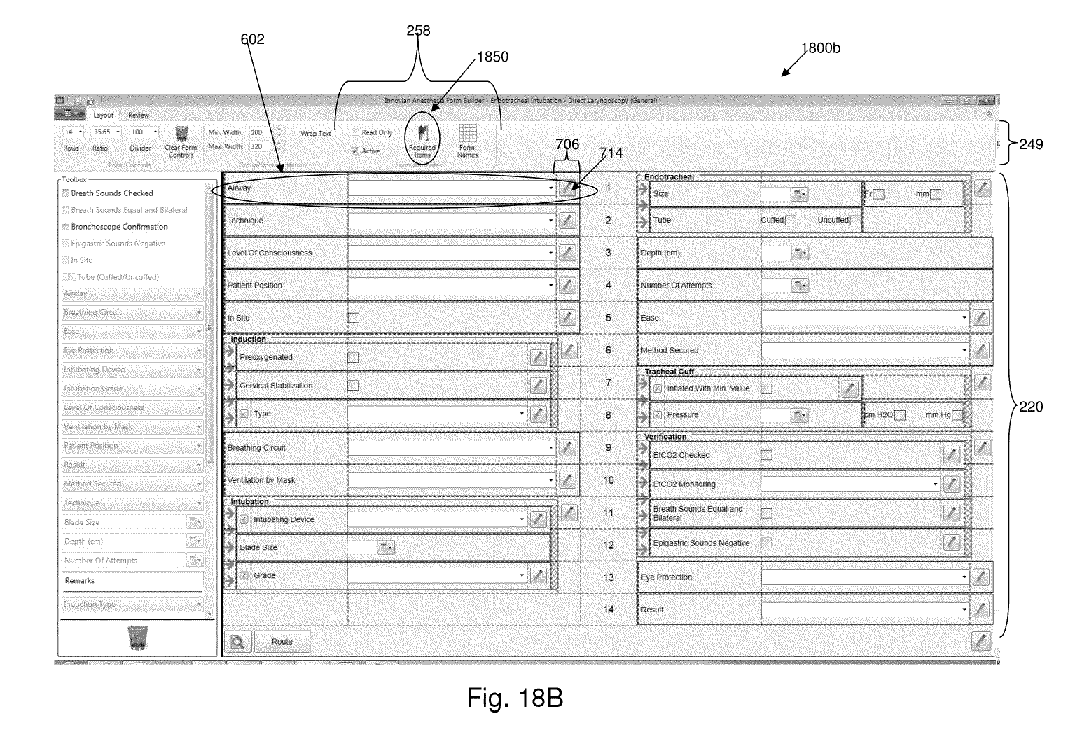

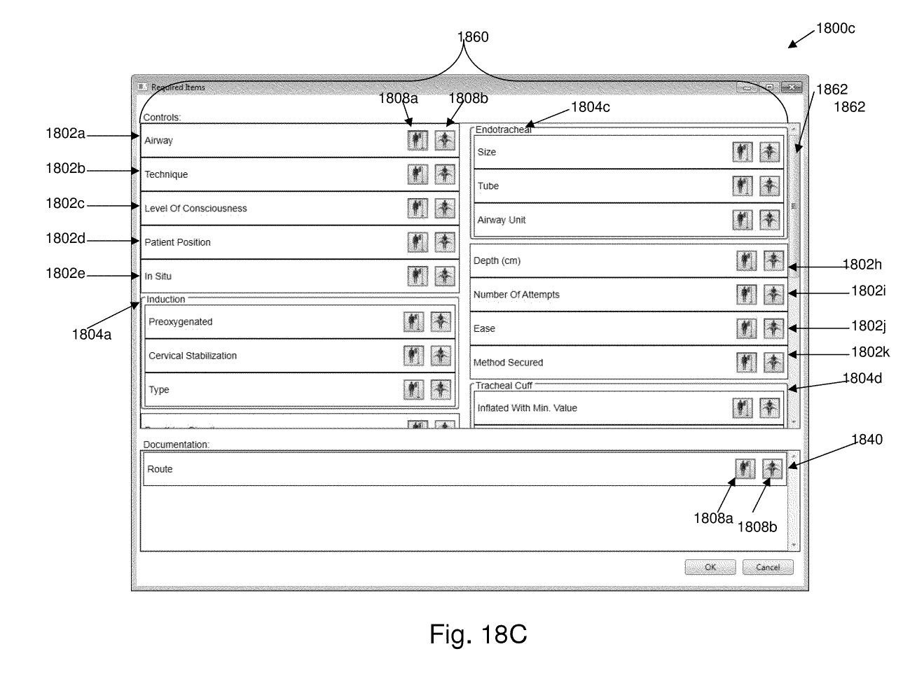

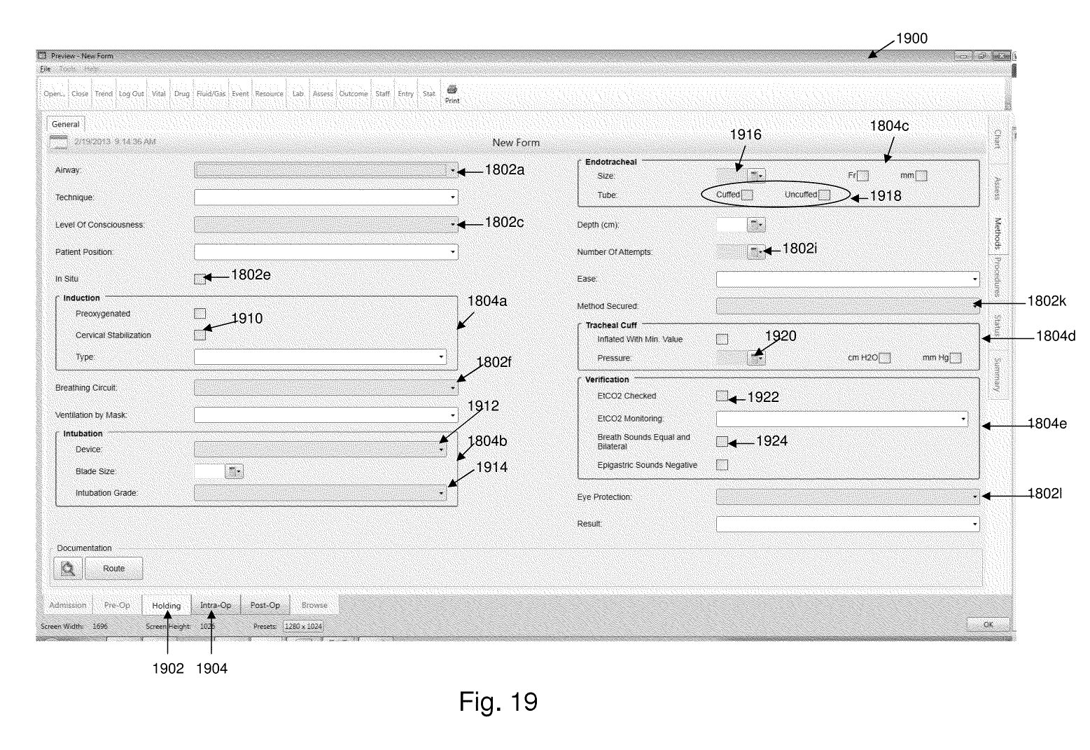

FIG. 18A represents one embodiment of a display image 1800a of a complete configured electronic form that includes a plurality of individual form control data objects 1802-a-1802m and a plurality of form control data object containers 1804a-1804e. Once the user has created the form, it is desirous to see how the form will look when presented to the provider charged with completing the form. To do this, the user creating the form may select the “review” tab 1806 which initiates the operation of the preview processor 108. The preview processor 108 automatically determines, from data representing the electronic form parameters generated by the form processor 102, the set of instructions for properly rendering the created electronic form. The determination as to the correct set of instructions may be performed using one of (a) the type of healthcare interaction; and (b) a predetermined program identifying the type of executable instructions needed for properly rendering the electronic form. The preview processor 108 provides an output of the electronic form to the UI generator 106 which generates a display image representative of the electronic form. An example of the completed form as generated by the UI generator 106 is shown in FIG. 19.

Returning back to FIG. 18A, in another embodiment, the electronic form being created to chronicle the particular healthcare interaction may include sub-interaction, or different stages that, when put together, comprise the complete healthcare interaction. Thus, the form building apparatus enables a user to selectively define which form control data objects are required to be completed at particular different stages of a healthcare interaction. The manner in which these stages may be selected will now be described with reference to a single form control data object 1802a. This is done for purpose of example only and each form control data object, whether it is an individual form control data object or a form control data object in a respective container, may be assigned as “required” for a particular stage of the healthcare interaction.

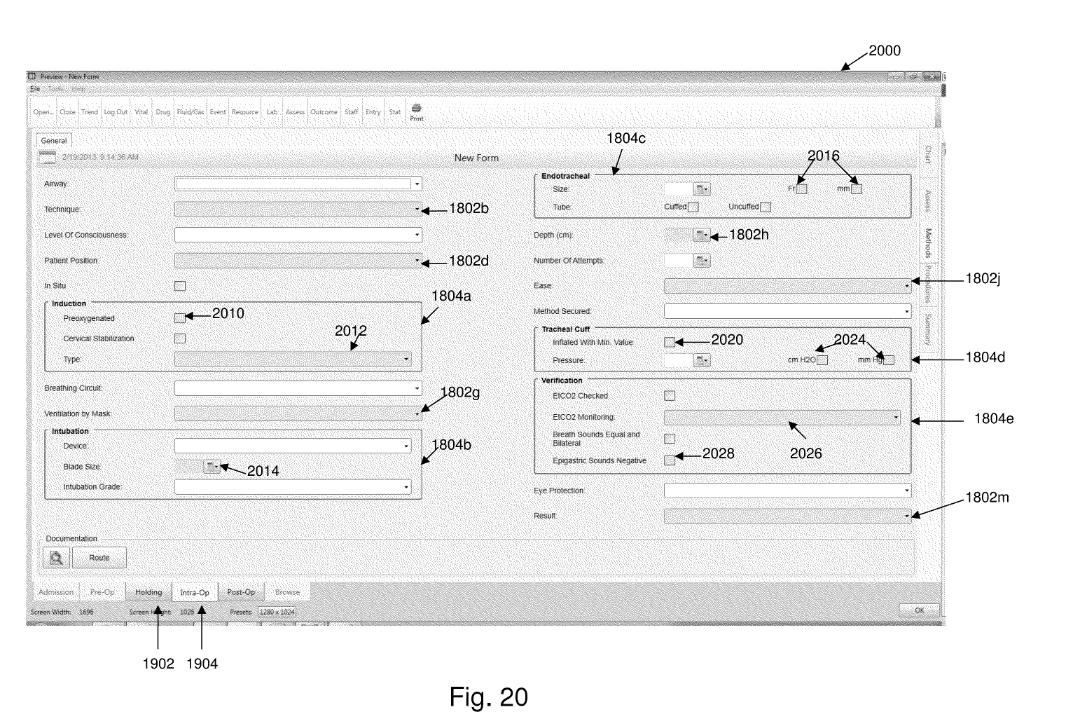

Form control data object 1802a includes stage selection icons 1808a and 1808b in the editing section 706 of the form control cell. As shown in this form, there are two possible stages to which each form control data object may be assigned. However, this is described for purposes of example only and, depending on the type and nature of the healthcare interaction being chronicled, any number of stage selections icons corresponding to different stages may be included in the editing section 706. In this example, the first stage selection icon 1808a is associated with a “holding stage” and the second stage selection icon 1808b is associated with a “intra-operative stage”. The user creating the form may activate corresponding stage icons 1808a and 1808b for each form control data object as needed. By selecting one or both of the stage icons 1808a and 1808b, the visual depiction of the associated form control data object is different than other form control data objects that do not have the stage icon 1808a/b selected. To see how these assignments are implemented and the visual differentiation therebetween, the user may select the review tab resulting in form data being provided to the preview processor 108 to generate a preview of the completed form. Examples of the electronic forms including mandatory form control data objects associated with respective stages is shown in FIGS. 19 and 20.

FIG. 18B represents an alternate embodiment of a display image 1800b of a complete configured electronic form that includes the same form control data objects and form control data object containers as those described in FIG. 18A. However, in this embodiment, the manner in which the user associates a respective stage with a respective form control data object differs. Instead of having the first stage selection icon 1808a and second stage selection icon 1808b in the editing section 706 of the form control cell 602 as in FIG. 18A, display image 1800b provides a stage assignment icon 1850 within the attribute section 250 of the formatting ribbon 249. Thus, the editing section 706 in each form control cell 602 includes only the form control data object editing icon 714. This simplifies the display to the user and facilitates quicker form design and editing of various form control data objects within the formatting grid 220.

In this embodiment, a user may assign form control data objects to different stages of the healthcare interaction by activating the stage assignment icon 1850 which automatically generates a dialogue box 1800c shown in FIG. 18C. Dialogue box 1800c includes a form control window 1860 that selectively displays at least a portion of the form control data objects currently present in display image 1800b in FIG. 18B. In the event that not all form control data objects are displayed in form control window 1860, a user may navigate using navigation bar 1862 to scroll through the various form control data objects in the form control window 1860. As shown herein, the form control window 1860 includes form control data objects 1802a-e and 1802h-k. The form control window 1860 also includes form control containers 1804a, 1804c and 1804d. Within each row that lists a respective form control data object, either on its own or within its respective container, are the first stage selection icons 1808a and second stage selection icons 1808b. By activating one or both stage selection icons 1808a and/or 1808b, a user may selectively assign that form control data object to be required within the completed form for the particular stage of the healthcare interaction.

Additionally, the stage assignment dialogue box 1800c may also include an auxiliary information window 1840 that selectively displays an indicator corresponding to any auxiliary information associated with the particular healthcare interaction being chronicled. In this embodiment, the auxiliary information includes documentation for the healthcare interaction of administering anesthesia. A user may select one of both of stage selection icons 1808a and/or 1808b to assign the associated documentation (e.g. auxiliary information) to be displayed in the completed form associated with the particular stage of the healthcare interaction.

While the stage assignment dialogue box 1800c includes two stage selection icons, it should be understood that this is for purposes of example only and different healthcare interactions may include different stages and the stage assignment dialogue box may include a number of stage selection icons corresponding to the number of stages associated with the particular healthcare interaction.

In FIG. 19, the electronic form for the first stage (e.g. holding stage) is shown. As determined during the form creation process, form control data objects 1802a, 1802c, 1802e, 1802f, 1802i, 1802k and 1802l were determined to be mandatory in the holding stage. Additionally, certain form control data objects within respective containers 1804a-1804e may also be selected. As shown herein, form control data objects 1910 in container 1804a is mandatory, form control data objects 1912 and 1914 in container 1804b are mandatory, form control data objects 1916 and 1918 in container 1804c are mandatory, form control data object 1920 in container 1804d is mandatory and form control data objects 1922 and 1924 in container 1804e are mandatory. The visual depiction of these form control data objects may be differentiated from other form control data objects. This may be accomplished by changing a background color associated with the mandatory form control image elements. This differentiation is described for purposes of example only and any method of changing the visual depiction of these form control data objects may be employed. To see the mandatory form control data objects in the intra-operative stage, a user may select the intra-operative tab 1904 resulting in the display image 2000 of FIG. 20 being displayed by the UI generator 106.

In FIG. 20, a preview of the electronic form for use during the intra-operative stage is shown as display image 2000. As determined during the form creation process, form control data objects 1802b, 1802d, 1802g, 1802h, 1802j, and 1802m were determined to be mandatory in the intraoperative stage. Additionally, certain form control data objects within respective containers 1804a-1804e may also be selected. As shown herein, form control data objects 2010 and 2012 in container 1804a are mandatory; form control data object 2014 in container 1804b is mandatory; form control data object 2016 in container 1804c are mandatory; form control data objects 2020 and 2024 in container 1804d are mandatory and form control data objects 2026 and 2028 in container 1804e are mandatory. The visual depiction of these form control data objects may be differentiated from other form control data objects. This may be accomplished by changing a background color associated with the mandatory form control image elements. This differentiation is described for purposes of example only and any method of changing the visual depiction of these form control data objects may be employed.

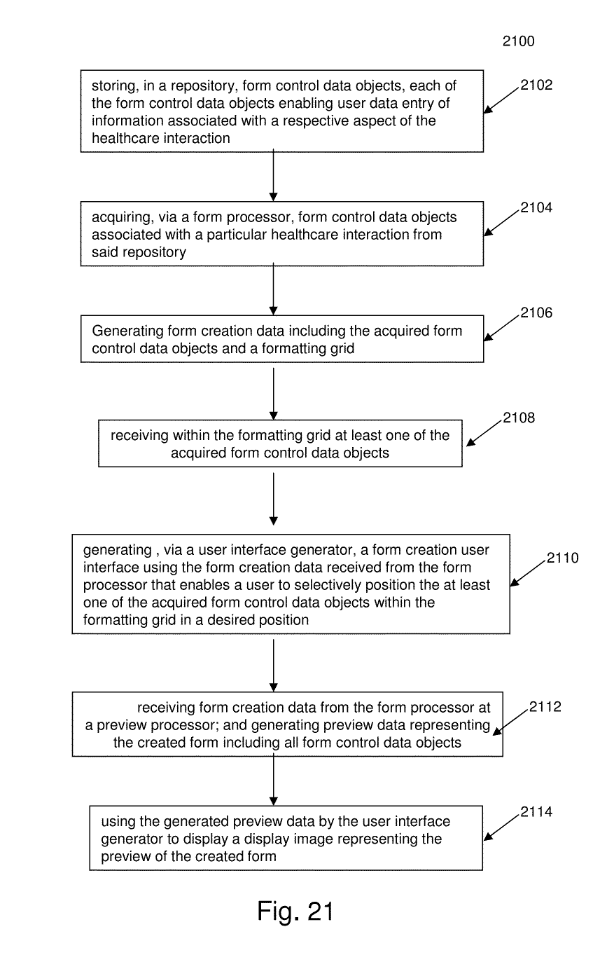

FIG. 21 is a flow diagram detailing operation of the form building apparatus discussed above in FIGS. 1-20. This flow diagram represents an algorithm 2100 that enables the creation of an electronic form for use in chronicling a healthcare interaction between a patient and healthcare provider. In block 2102, form control data objects are stored in a repository and each of the form control data objects enables user data entry of information associated with a respective aspect of the healthcare interaction. Each form control data object includes a set of executable instructions that allows for input of a particular type of information item describing a respective aspect of the healthcare interaction. In one embodiment, each form control data objects includes a label describing a respective form control data object and form control type that identifies a manner in which data entry of information occurs via the form control data object. In another embodiment, the form control type of each respective form control data object includes at least one of (a) a drop down box that provides a user with a set of candidate data items able to be selected; (b) a check box that enables indication of presence or absence of a particular information item; and (c) a free form text box enabling entry of alphanumeric characters to describe the information item. In a further embodiment, each form control data object includes respective auxiliary information associated therewith. In one embodiment, block 2102 may also include automatically acquiring, from the repository, a candidate set of form control data objects based on the particular healthcare interaction.

In block 2104, a form processor acquires form control data objects associated with a particular healthcare interaction from said repository. The form processor generates form creation data including the acquired form control data objects and a formatting grid in block 2106. In one embodiment, the generation of the formatting grid in block 2106 may further include creating at least one form control cell for receiving the at least one form control data object, the form control cell including a label section for displaying the label describing the form control data object and a data input section for displaying an image representative of the type of form control data object contained therein. In a further embodiment, the creation of the form control cell in block 2106 includes generating an editing section including a user selectable image element that enables the user to edit at least one parameter associated with the type of form control data object. In this embodiment, a user is automatically preventing re-selection of a previously selected form control data object. The at least one parameter may include at least one of (a) a type of information item able to be entered via the form control data object; (b) a display format associated with the type of form control data object; and (c) a size of the form control cell within the formatting grid. In another embodiment, the block 2106 may enable generation of a container selectively positionable within the formatting grid wherein the container including a plurality of form control data objects grouped together. A user may selectively control at least one parameter that defines a format associated with the container and includes form control data items via the form processor. In a further embodiment, wherein the healthcare interaction comprises at least two healthcare interaction stages, block 2104 may also enable selection of particular form control data objects for assignment to at least one of the at least two healthcare interaction stages.

In block 2108, the at least one of the acquired form control data objects are received within the formatting grid. A user interface generator, generates a form creation user interface using the form creation data received from the form processor that enables a user to selectively position the at least one of the acquired form control data objects within the formatting grid in a desired position in block 2110. In block 2112, form creation data generated by the form processor may be received by a preview processor that generates preview data representing the created form including all form control data objects. The preview data is used by the user interface generator to display a display image representing the preview of the created form in block 2114.

The form building apparatus, as discussed above with respects to FIGS. 1-21 advantageously provides a user with the ability to quickly and easily create electronic forms that enable a healthcare provider to chronicle patient information associated with particular healthcare interactions. The apparatus employs a repository of discretely coded objects that include instructions that enable input of at least one type of information item that describes the healthcare interaction. This advantageously reduces the time and cost attributed to a healthcare enterprise for creating patient data entry forms and allows various users (who may also be healthcare providers) to create forms that are most convenient and appropriate for their use via a drag and drop interface. As the user creating the form is manipulating only image element representative of coded objects, the user can focus on the layout and positioning of objects in the form instead of the underlying instructions needed to enable inputting of the desired information. Moreover, these objects are each editable to allow the user to customize the manner in which the information may be input as well as the visual formatting of the object within the form. Thus, the form building apparatus of FIGS. 1-20 provides a fully customizable form creation apparatus for a user to create an electronic form for chronicling information associated with a particular healthcare interaction.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. An apparatus that creates an electronic form used to chronicle a healthcare interaction between a patient and healthcare provider, the apparatus comprising:
a repository that stores form control data objects, each of the form control data objects enabling user data entry of information associated with a respective aspect of the healthcare interaction;
a form processor that acquires form control data objects associated with a particular healthcare interaction from said repository and generates form creation data including the acquired form control data objects and a formatting grid, said formatting grid receives at least one of the acquired form control data objects; and
a user interface generator that generates a form creation user interface using the form creation data received from the form processor that enables a user to selectively position the at least one of the acquired form control data objects within the formatting grid in a desired position.

2. The apparatus according to claim 1, wherein
each form control data object includes a link to a set of executable instructions that allows for input of a particular type of information item describing a respective aspect of the healthcare interaction.

3. The apparatus according to claim 1, wherein
each form control data objects each includes a label describing a respective form control data object and form control type that identifies a manner in which data entry of information occurs via the form control data object.

4. The apparatus according to claim 3, wherein
the form control type of each respective form control data object includes at least one of (a) a drop down box that provides a user with a set of candidate data items able to be selected; (b) a check box that enables indication of presence or absence of a particular information item; (c) a free form text box enabling entry of alphanumeric characters to describe the information item; and (d) an exclusivity box that provides a plurality of information items for selection wherein only one of the information items may be selected at a given time.

5. The apparatus according to claim 3, wherein
each form control data object includes respective auxiliary information associated therewith.

6. The apparatus according to claim 3, wherein
the formatting grid generated by the form processor includes at least one form control cell for receiving the at least one form control data object, the form control cell including a label section for displaying the label describing the form control data object and a data input section for displaying an image representative of the type of form control data object contained therein.

7. The apparatus according to claim 6, wherein
the at least one form control cell further includes an editing section including a user selectable image element that enables the user to edit at least one parameter associated with the type of form control data object.

8. The apparatus according to claim 7, wherein
the at least one parameter includes (a) a type of information item able to be entered via the form control data object; (b) a display format associated with the type of form control data object; and (c) a size of the form control cell within the formatting grid.

9. The apparatus according to claim 1, wherein
the form processor generates a container selectively positionable within the formatting grid, the container including a plurality of form control data objects grouped together.

10. The apparatus according to claim 9, wherein
the form processor selectively controls at least one parameter defining a format associated with the container and includes form control data items.

11. The apparatus according to claim 1, further comprising a preview processor that selectively receives form creation data from the form processor and generates preview data representing the created form including all form control data objects.

12. The apparatus according to claim 11, wherein
the preview data is used by the user interface generator to display a display image representing the preview of the created form.

13. The apparatus according to claim 1, wherein
the form processor automatically acquires a candidate set of form control data objects based on the particular healthcare interaction.

14. The apparatus according to claim 1, wherein
the healthcare interaction comprises at least two healthcare interaction stages and, the form processor selectively enables selection of particular form control data objects for assignment to at least one of the at least two healthcare interaction stages.

15. The apparatus according to claim 1, wherein
the form processor automatically prevents re-selection of a previously selected form control data object.

16. A method of creating an electronic form used to chronicle a healthcare interaction between a patient and healthcare provider, comprising the activities of
storing, in a repository, form control data objects, each of the form control data objects enabling user data entry of information associated with a respective aspect of the healthcare interaction;
acquiring, via a form processor, form control data objects associated with a particular healthcare interaction from said repository;
generating form creation data including the acquired form control data objects and a formatting grid, receiving within the formatting grid at least one of the acquired form control data objects; and
generating, via a user interface generator, a form creation user interface using the form creation data received from the form processor that enables a user to selectively position the at least one of the acquired form control data objects within the formatting grid in a desired position.

17. The method according to claim 16, wherein
each form control data object includes a set of executable instructions that allows for input of a particular type of information item describing a respective aspect of the healthcare interaction.

18. The method according to claim 16, wherein
each form control data objects each includes a label describing a respective form control data object and form control type that identifies a manner in which data entry of information occurs via the form control data object.

19. The method according to claim 18, wherein
the form control type of each respective form control data object includes at least one of (a) a drop down box that provides a user with a set of candidate data items able to be selected; (b) a check box that enables indication of presence or absence of a particular information item; and (c) a free form text box enabling entry of alphanumeric characters to describe the information item.

20. The method according to claim 18, wherein
each form control data object includes respective auxiliary information associated therewith.

21. The method according to claim 18, wherein the activity of generating the format grid further includes
creating at least one form control cell for receiving the at least one form control data object, the form control cell including a label section for displaying the label describing the form control data object and a data input section for displaying an image representative of the type of form control data object contained therein.

22. The method according to claim 21, wherein the activity of creating the at least one form control cell further comprises
generating an editing section including a user selectable image element that enables the user to edit at least one parameter associated with the type of form control data object.

23. The method according to claim 22, wherein
the at least one parameter includes (a) a type of information item able to be entered via the form control data object; (b) a display format associated with the type of form control data object; and (c) a size of the form control cell within the formatting grid.

24. The method according to claim 16, further comprising
generating a container selectively positionable within the formatting grid, the container including a plurality of form control data objects grouped together.

25. The method according to claim 24, further comprising
selectively controlling at least one parameter defining a format associated with the container and includes form control data items via the form processor.

26. The method according to claim 16, further comprising
receiving form creation data from the form processor at a preview processor; and
generating preview data representing the created form including all form control data objects.

27. The method according to claim 26, further comprising
using the generated preview data by the user interface generator to display a display image representing the preview of the created form.

28. The method according to claim 16, further comprising
automatically acquiring, from the repository, a candidate set of form control data objects based on the particular healthcare interaction.

29. The method according to claim 16, wherein
the healthcare interaction comprises at least two healthcare interaction stages and, further comprising
enabling selection of particular form control data objects for assignment to at least one of the at least two healthcare interaction stages.

30. The method according to claim 16, wherein
automatically preventing re-selection of a previously selected form control data object.
